(19) United States
(12) Patent Application Publication
(10) Pub. No.: US 2026/0091645 A1
(43) Pub. Date: Apr. 2, 2026

(54) VEHICLE AIR-CONDITIONING APPARATUS

(71) Applicant: HANON SYSTEMS, Daejeon (KR)

(72) Inventors: Yong Eun SEO, Daejeon (KR); Ho Young LEE, Daejeon (KR); Jae Won JEONG, Daejeon (KR)

(21) Appl. No.: 19/344,594

(22) Filed: Sep. 30, 2025

(30) Foreign Application Priority Data
Aug. 19, 2025 (KR) 10-2025-0115137
Oct. 2, 2024 (KR) 10-2024-0133974
Oct. 2, 2024 (KR) 10-2024-0133979

(51) Int. Cl. B60H 1/00

(52) U.S. Cl. CPC B60H 1/00671

(57) ABSTRACT

According to one embodiment, a vehicle air-conditioning apparatus, which is connected to a front seat air-conditioning apparatus and provides conditioned air toward a rear seat of a vehicle, includes a housing which includes an inlet part through which air discharged from the front seat air-conditioning apparatus is introduced and a discharge unit part which discharges air to the rear seat and is divided into a first inner space and a second inner space, a door which is disposed in each of the first inner space and the second inner space and determines a moving direction of air, and an actuator which rotates the door, wherein the actuator is disposed between the first inner space and the second inner space.

### CROSS-REFERENCE TO RELATED APPLICATION

This application claims priority to and the benefit of Korean Patent Application No. 10-2024-0133974, filed on October 02, 2024, Korean Patent Application No. 10-2024-0133979, filed on October 02, 2024, and Korean Patent Application No. 10-2025-0115137, filed on August 19, 2025, the entire disclosures of which are incorporated herein by reference in their entirety.

### BACKGROUND

### 1. Field of the Invention

The present invention relates to a vehicle air-conditioning apparatus, and more specifically, to a vehicle air-conditioning apparatus disposed between a driver’s seat and a passenger seat.

### 2. Discussion of Related Art

An air-conditioning module installed in a vehicle may provide conditioned air to a passenger room of the vehicle and cool or heat the air moved by a blower unit. The air-conditioning module may provide the conditioned air to a front seat region in which a driver’s seat and a passenger seat of the vehicle are disposed and a rear seat region disposed behind the front seat region.

The air-conditioning module may include a module which is installed in a cockpit module and discharges the conditioned air toward the front seat region of the vehicle and a module which is disposed between the driver’s seat and the passenger seat and discharges the conditioned air toward the rear seat region of the vehicle. Among them, the air-conditioning module (hereinafter, a rear seat air-conditioning module) disposed between the driver’s seat and the passenger seat may be disposed in an armrest installed between the driver’s seat and the passenger seat.

The rear seat air-conditioning module may include the blower unit which blows air and an air guide unit which guides the air blown by the blower unit. Among them, the air guide unit may move the air blowen by the blower unit toward an upper portion or lower portion of the rear seat region of the vehicle.

The air guide unit may include a housing in which an inlet port, through which air is introduced, an upper discharge port, and a lower discharge portion are formed, a door unit which is disposed in the housing and selectively opens and closes air moving spaces in the housing, and an actuator which is connected to the door unit and rotates the door unit.

Among them, the actuator may be directly connected to the door unit to rotate the door unit, and, in this case, the actuator may be disposed on an outer surface of the housing. Such an actuator may be disposed at one side or the other side of the housing. In this case, when air is discharged from the housing, a discharge area may be reduced.

In addition, the actuator disposed on the outer surface of the housing may result in an increase in total width of the air guide unit to cause a problem of increasing a difficulty in installing the actuator in the armrest.

### SUMMARY OF THE INVENTION

The present invention is to solve the above-described problems, and the embodiment of the present invention is directed to providing a vehicle air-conditioning apparatus improved to secure an air discharge area.

A vehicle air-conditioning apparatus, which provides conditioned air to a vehicle interior, according to the embodiment of the present invention includes a housing which includes an inlet part through which air is introduced and a discharge unit part which discharges air and is divided into a first inner space and a second inner space, a door which is disposed in each of the first inner space and the second inner space and determines a moving direction of air, and an actuator which rotates the door, wherein the actuator is disposed between the first inner space and the second inner space.

The discharge unit part may include a first discharge part which discharges air toward an upper side and a second discharge part which discharges air toward a lower side, wherein the actuator may be disposed between the plurality of discharge part and the second discharge part.

The second discharge part and the actuator may be disposed within a left-right width of the first discharge part.

The vehicle air-conditioning apparatus may include a first duct which allows air to flow to the first inner space, a second duct which allows air to flow to the second inner space, and a blower unit which is disposed between the first duct and the second duct and discharges air toward the housing.

The vehicle air-conditioning apparatus may include a separator which separates the first inner space and the second inner space, wherein the housing may include a first case unit in which the first inner space and a first outer space are formed and a second case unit in which the second inner space and a second outer space are formed, and the actuator may be disposed in each of the first outer space and the second outer space which are formed between the first inner space and the second inner space.

The actuator may be disposed close to the separator and spaced apart from the first case unit and the second case unit.

The actuator may be disposed in each of a right outer portion of the first case unit and a left outer portion of the second case unit.

The actuator may include a first actuator disposed in the first outer space and a second actuator disposed in the second outer space, and the door may include a first door disposed in the first inner space and a second door disposed in the second inner space.

The vehicle air-conditioning apparatus may include a first lever which is disposed in the first outer space and connects the first actuator and the first door and a second lever which is disposed in the second outer space and connects the second actuator and the second door.

The first lever may include a 1-1 lever plate rotatably connected to the first actuator and a 1-2 lever plate which connects the first door and the 1-1 lever plate, and the second lever may include a 2-1 lever plate rotatably connected to the second actuator and a 2-2 lever plate which connects the second door and the 2-1 lever plate.

The first case unit of the housing may include a first case frame disposed to be spaced apart from the separator and a second case frame which is disposed between the first case frame and the separator and connects the first case frame and the separator, and the second case unit of the housing may include a third case frame disposed to be spaced apart from the separator and a fourth case frame which is disposed between the third case frame and the separator and connects the third case frame and the separator.

The first discharge part may include a 1-1 discharge part which is formed by the first case unit and discharges air to the lower side and a 1-2 discharge part which is formed by the second case unit and discharges air to the lower side.

The second discharge part may include a 2-1 discharge part formed by the first case unit and the separator and a 2-2 discharge part formed by the second case unit and the separator.

The first door may be rotatably coupled to the first case unit, the second door may be rotatably coupled to the second case unit, and a rotation center of the first door and a rotation center of the second door may be disposed to be colinear with each other.

The separator may include a partition plate which separates the first inner space and the second inner space and divide the inlet part, wherein the partition plate may be coupled to the actuators to support the actuators. The actuator may be disposed between the first case unit and the second case unit of the housing and disposed at each of one side and the other side of the partition plate of the separator.

The actuator may be disposed between the first case unit and the second case unit of the housing and disposed to be closer to the separator than the first case unit and the second case unit.

The separator may include a shielding plate which is coupled to the partition plate and forms the inlet part with the first case unit and the second case unit of the housing.

The separator may include a fixing protrusion which is disposed on an end portion of the partition plate and of which both end portions are fixed to the first case unit and the second case unit of the housing.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a front seat air-conditioning apparatus and a vehicle air-conditioning apparatus according to an embodiment of the present invention;

FIG. 2 is a plan perspective view illustrating the vehicle air-conditioning apparatus according to the embodiment of the present invention;

FIG. 3 is a bottom perspective view illustrating the vehicle air-conditioning apparatus according to the embodiment of the present invention;

FIG. 4 is an exploded perspective view illustrating the vehicle air-conditioning apparatus according to the embodiment of the present invention;

FIG. 5 is an exploded perspective view illustrating a first case unit of a housing;

FIG. 6 is a perspective view illustrating a second case frame of the first case unit;

FIG. 7 is a view illustrating the first case unit to which a first door coupled;

FIG. 8 is a view illustrating a first discharge part formed in the first case unit;

FIG. 9 is an exploded perspective view illustrating a second case unit of the housing;

FIG. 10 is a view illustrating the second case unit to which a second door is coupled;

FIG. 11 is a view illustrating a second discharge part formed in the second case unit;

FIG. 12 is a perspective view illustrating a separator;

FIG. 13 is a view illustrating a first inlet part and a second inlet part formed by the first case unit, the second case unit, and the separator;

FIG. 14 is a view illustrating a first outer space and a second outer space formed by the first case unit, the second case unit, and the separator;

FIGS. 15A and 15B are views illustrating a third stopper part of the separator;

FIG. 16 is a perspective view illustrating a first door unit;

FIG. 17 is a view illustrating the first door unit disposed on the housing and the separator;

FIG. 18 is a perspective view illustrating a second door unit;

FIG. 19 is a view illustrating the second door unit disposed on the housing and the separator;

FIG. 20 is a view illustrating a first actuator and a second actuator disposed in the first outer space and the second outer space;

FIG. 21 is a view illustrating the first door unit and the second door unit which are disposed on the housing and the separator;

FIG. 22 is a front view illustrating the vehicle air-conditioning apparatus according to the embodiment of the present invention;

FIG. 23 is a perspective view illustrating a vehicle air-conditioning apparatus according to another embodiment of the present invention;

FIG. 24 is a view illustrating a first case unit;

FIG. 25 is a view illustrating a second case unit;

FIG. 26 is a view illustrating a first actuator;

FIG. 27 is a view illustrating the first actuator coupled to the first case unit;

FIG. 28 is a view illustrating a second actuator;

FIG. 29 is a view illustrating the second actuator coupled to the second case unit;

FIG. 30 is a view illustrating a separator;

FIG. 31 is a view illustrating a first inlet part and a second inlet part formed by the first case unit, the second case unit, and the separator; and

FIG. 32 is a view illustrating a third outer space formed by the first case unit, the second case unit, and the separator.

### DETAILED DESCRIPTION OF EXEMPLARY EMBODIMENTS

Hereinafter, exemplary embodiments of the present invention will be described in detail with reference to the accompanying drawings.

However, the technical spirit of the present invention is not limited to the few embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

The terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is “connected,” “coupled,” or “linked” to the second component with a third component disposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when the first component is described as being formed “on (above) or under (below)” the second component, such a description may include a case in which the first component is formed at an upper side or a lower side with respect to the second component.

Hereinafter, when a vehicle air-conditioning apparatus will be described in detail with reference to the accompanying drawings, components that are the same or correspond to each other will be denoted by the same or corresponding reference numerals in all drawings, and redundant descriptions thereof will be omitted.

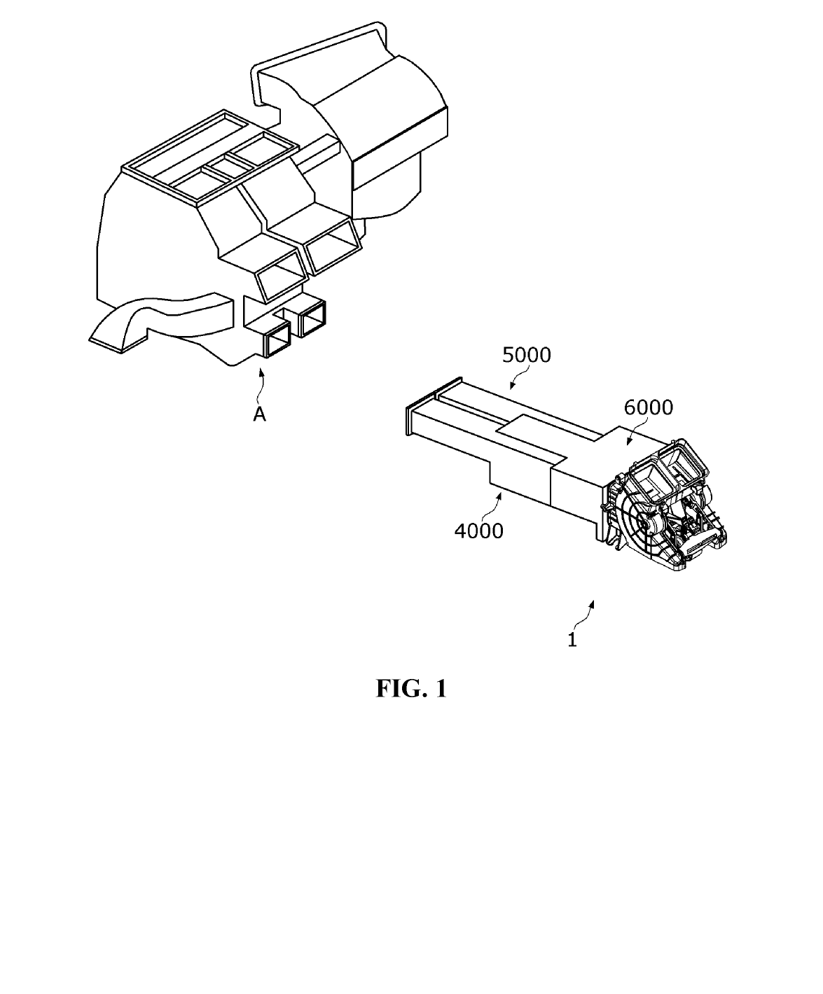

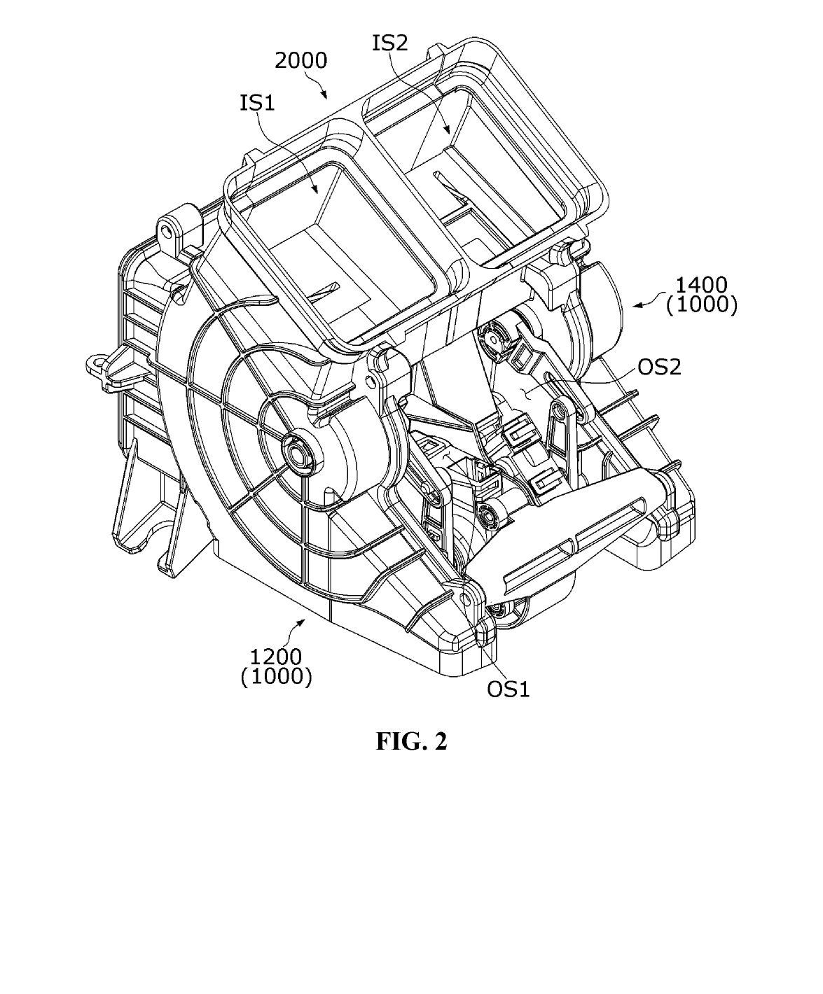

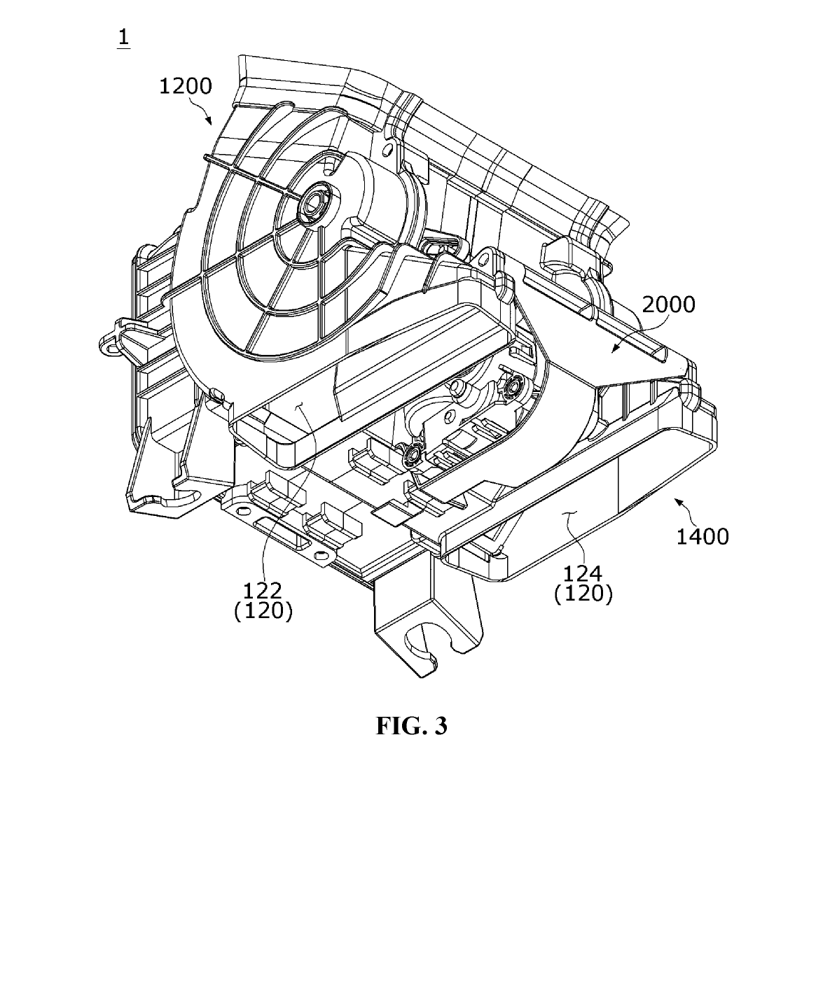

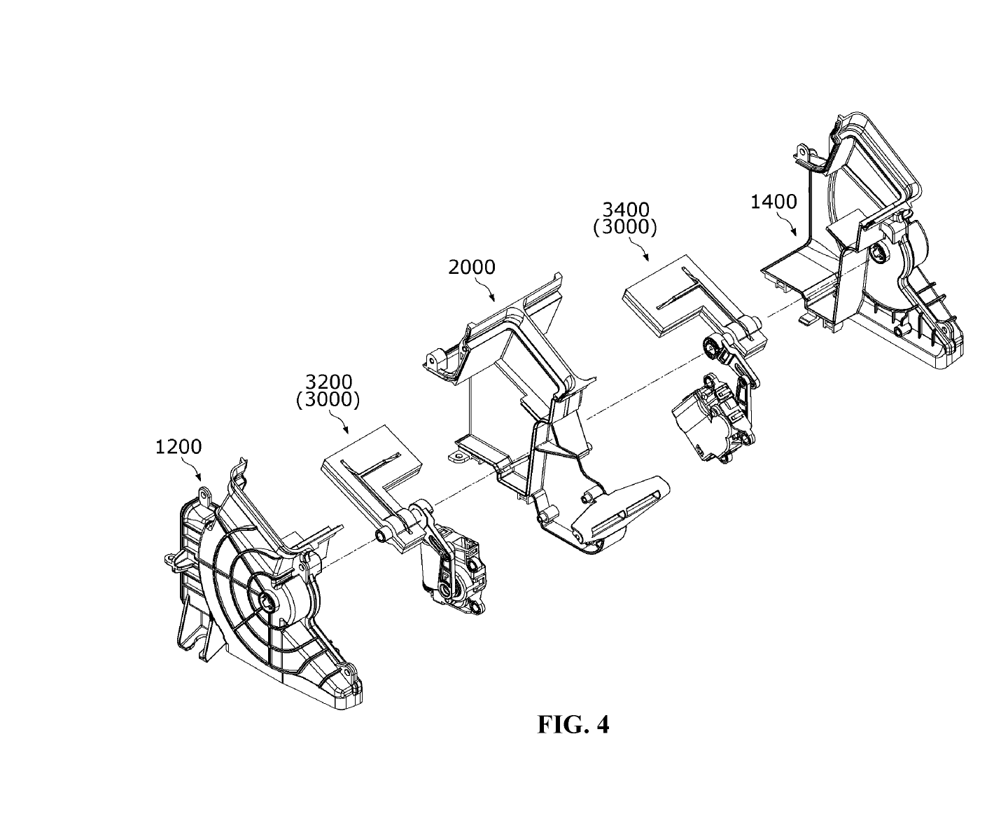

FIG. 1 is a view illustrating a front seat air-conditioning apparatus and a vehicle air-conditioning apparatus according to an embodiment of the present invention, and FIG. 2 is a plan perspective view illustrating the vehicle air-conditioning apparatus according to the embodiment of the present invention. FIG. 3 is a bottom perspective view illustrating the vehicle air-conditioning apparatus according to the embodiment of the present invention, and FIG. 4 is an exploded perspective view illustrating the vehicle air-conditioning apparatus according to the embodiment of the present invention.

Referring to FIG. 1, a vehicle air-conditioning apparatus 1 according to the embodiment of the present invention may be a part of an air-conditioning module installed in a vehicle. More specifically, in the vehicle, a front seat air-conditioning apparatus A which discharges conditioned air toward a front seat region (in which a driver’s seat and a passenger seat are installed) of a driving room and a rear seat air-conditioning apparatus which discharges conditioned air toward a rear seat region (behind the front seat region). The vehicle air-conditioning apparatus 1 may be disposed in an armrest box disposed between the driver’s seat and the passenger seat of the vehicle. In addition, the vehicle air-conditioning apparatus 1 may be connected to the front seat air-conditioning apparatus A and may provide the conditioned air toward a rear seat. Referring to FIGS. 2 to 4, the vehicle air-conditioning apparatus 1 includes a housing 1000, a separator 2000, and a door unit 3000.

In addition, the vehicle air-conditioning apparatus 1 according to the embodiment of the present invention may include a first duct 4000 which allows air discharged from the front seat air-conditioning apparatus A to flow to the vehicle air-conditioning apparatus 1, a second duct 5000 which allows air to flow to the vehicle air-conditioning apparatus 1 like the first duct 4000, and a blower unit 6000 which is disposed between the first duct 4000 and the second duct 5000 and discharges air toward the housing 1000. In this case, the first duct 4000, the second duct 5000, and the blower unit 6000 may be disposed in the armrest box.

The housing 1000 may include a plurality of case units which accommodate air to be discharged toward the rear seat of the vehicle and are disposed in parallel. The plurality of case units may include a first case unit 1200 and a second case unit 1400.

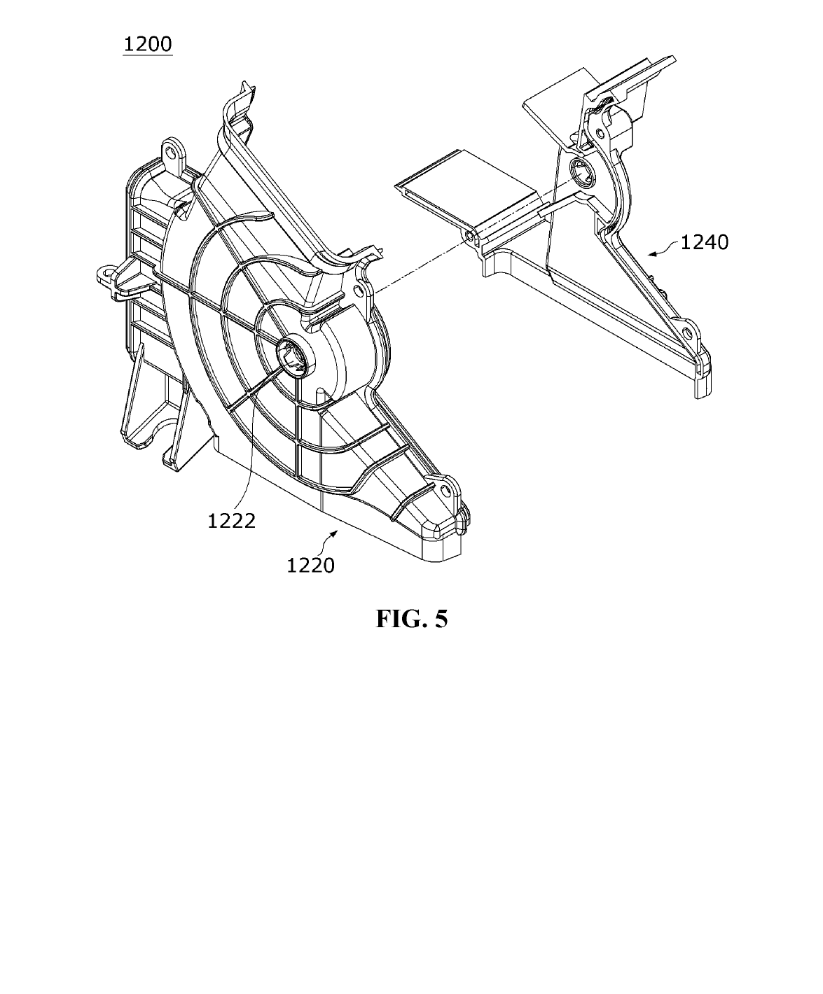

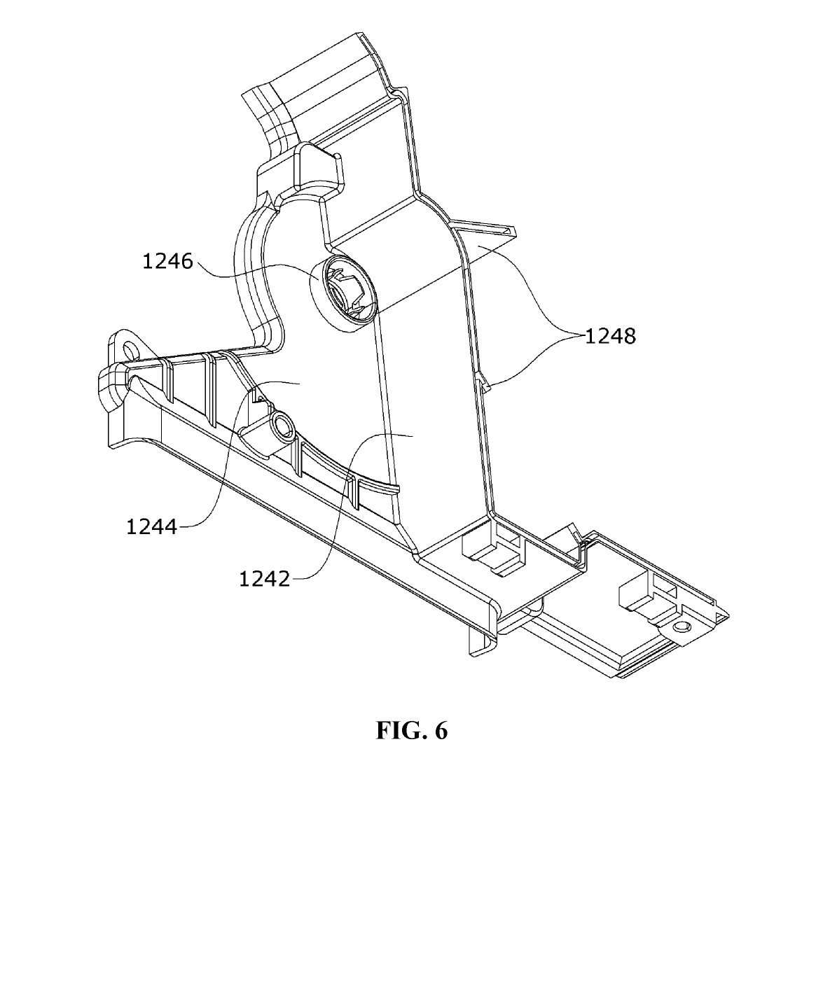

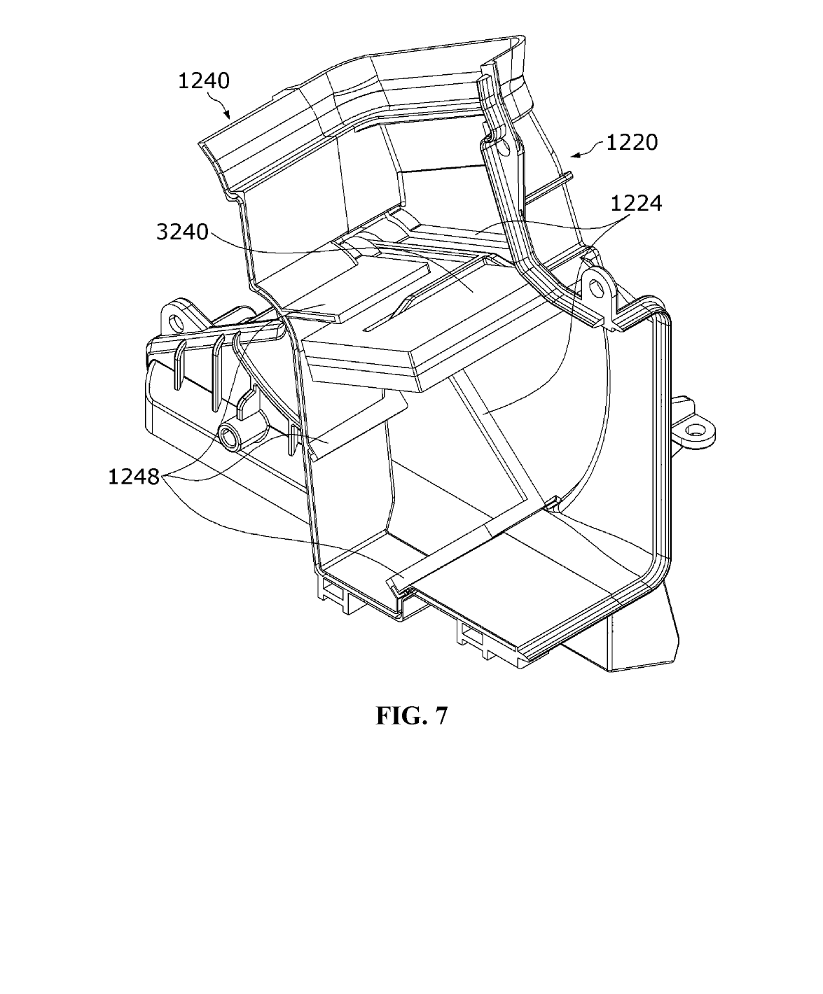

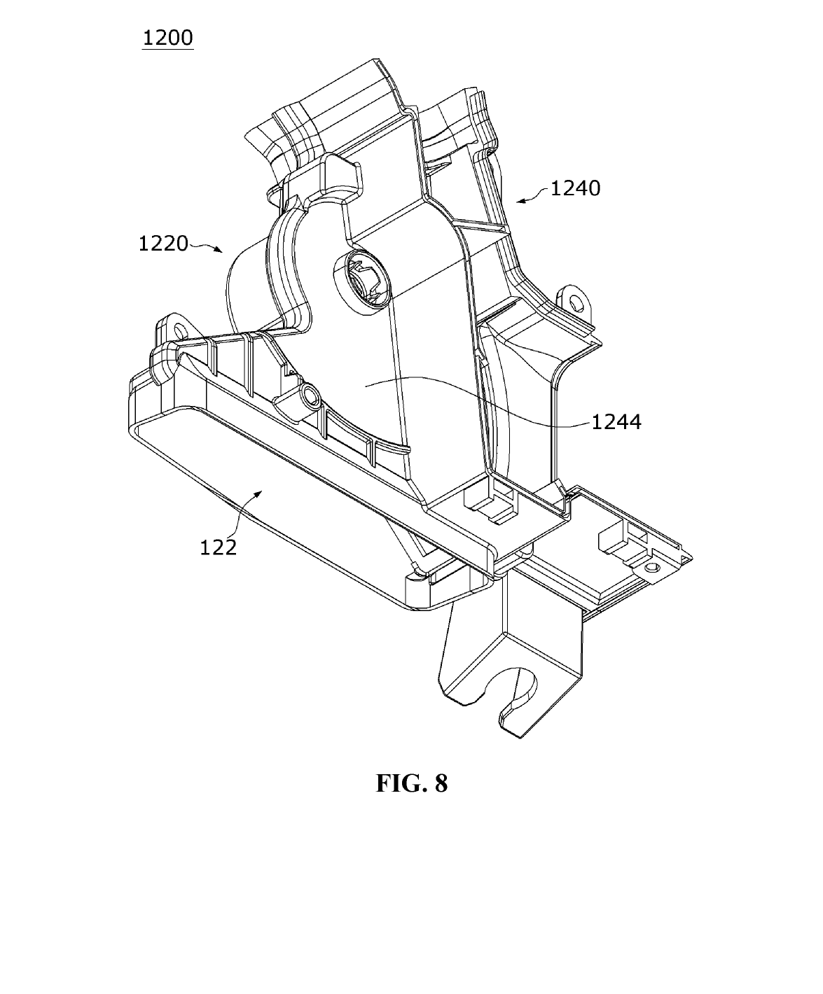

FIG. 5 is an exploded perspective view illustrating the first case unit of the housing, and FIG. 6 is a perspective view illustrating a second case frame of the first case unit. FIG. 7 is a view illustrating the first case unit to which a first door coupled, and FIG. 8 is a view illustrating a first discharge part formed in the first case unit.

Referring to FIGS. 4 to 8, with the separator 2000, the first case unit 1200 may form a first inner space IS1 and a first outer space OS1 (see FIG. 1). The first case unit 1200 may include a first case frame 1220 and a second case frame 1240.

The first case frame 1220 may be disposed to be spaced apart from the separator 2000. With the second case frame 1240, the first case frame 1220 may form a portion of the housing 1000. The first case frame 1220 may be a component disposed at an outermost side of the vehicle air-conditioning apparatus 1. The first case frame 1220 may include a 1-1 accommodation part 1222 and a 1-1 stopper part 1224.

The 1-1 accommodation part 1222 may be formed on the first case frame 1220. The 1-1 accommodation part 1222 may rotatably support a first shaft part 3244 of a first door unit 3200 which will be described below. The 1-1 accommodation part 1222 may be disposed at one side (outside) of a first partition plate 1242 based on the first partition plate 1242 of the second case frame 1240 in a state in which the first case frame 1220 is coupled to the second case frame 1240.

The 1-1 stopper part 1224 may be disposed on a surface of the first case frame 1220 which is not exposed to the outside. The 1-1 stopper part 1224 may be a plurality of protruding parts protruding from the first case frame 1220. The plurality of protruding parts forming the 1-1 stopper part 1224 may block movement of a first door 3240, which will be described below, to prevent the first door 3240 from rotating at a predetermined angle or more. That is, the 1-1 stopper part 1224 may be disposed on a rotation path of the first door 3240 which will be described below.

The second case frame 1240 may be coupled to the first case frame 1220. The second case frame 1240 may be disposed between the first case frame 1220 and the separator 2000 and may connect the first case frame 1220 and the separator 2000. The second case frame 1240 may include the first partition plate 1242, a first side plate 1244, a 1-2 accommodation part 1246, and a 1-2 stopper part 1248.

The first partition plate 1242 may isolate the first inner space IS1 from the first outer space OS1 which are formed by the first case unit 1200 and the separator 2000 (see FIG. 2). As illustrated in FIG. 6, the first partition plate 1242 may be one of components forming a first inlet part 220, which will be described below, and a 2-1 discharge part 142.

The first side plate 1244 may be formed in a shape bent from the first partition plate 1242 and may form the first outer space OS1 with the first partition plate 1242 and the separator 2000 (see FIG. 2). The first side plate 1244 may shield an open portion of the first case frame 1220.

The 1-2 accommodation part 1246 may be formed on the first side plate 1244. The 1-2 accommodation part 1246 may be disposed to be collinear with the 1-1 accommodation part 1222 formed on the first case frame 1220. The 1-2 accommodation part 1246 may rotatably support the first shaft part 3244 of the first door unit 3200 which will be described below. As illustrated in FIG. 8, the 1-2 accommodation part 1246 may be disposed at one side (outside) of a second partition plate 1442 based on the second partition plate 1442 of a fourth case frame 1440.

The 1-2 stopper part 1248 may be disposed on the first partition plate 1242. The 1-2 stopper part 1248 may be a plurality of protruding parts protruding from the first partition plate 1242. The plurality of protruding parts forming the 1-2 stopper part 1248 may block the movement of the first door 3240, which will be described below, to prevent the first door 3240 from rotating at the predetermined angle or more. That is, the 1-2 stopper part 1248 may be disposed on the rotation path of the first door 3240 which will be described below. In addition, in a state in which the second case frame 1240 is coupled to the first case frame 1220, the 1-2 stopper part 1248 may be disposed to be colinear with the 1-1 stopper part 1224.

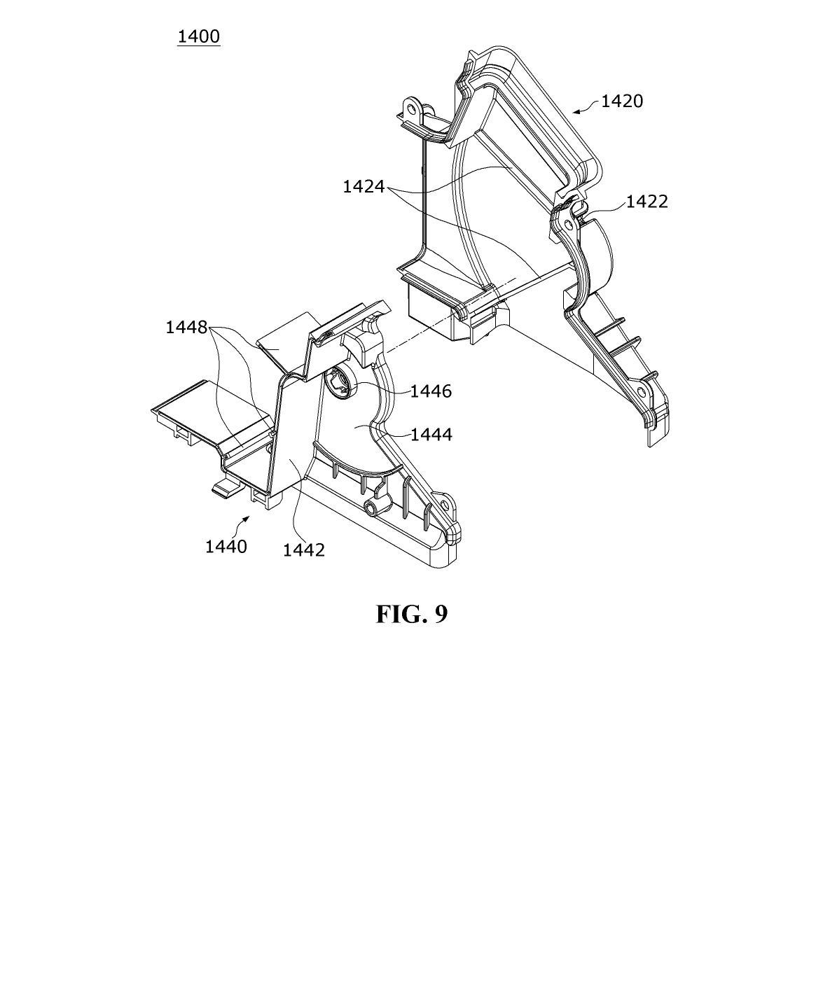

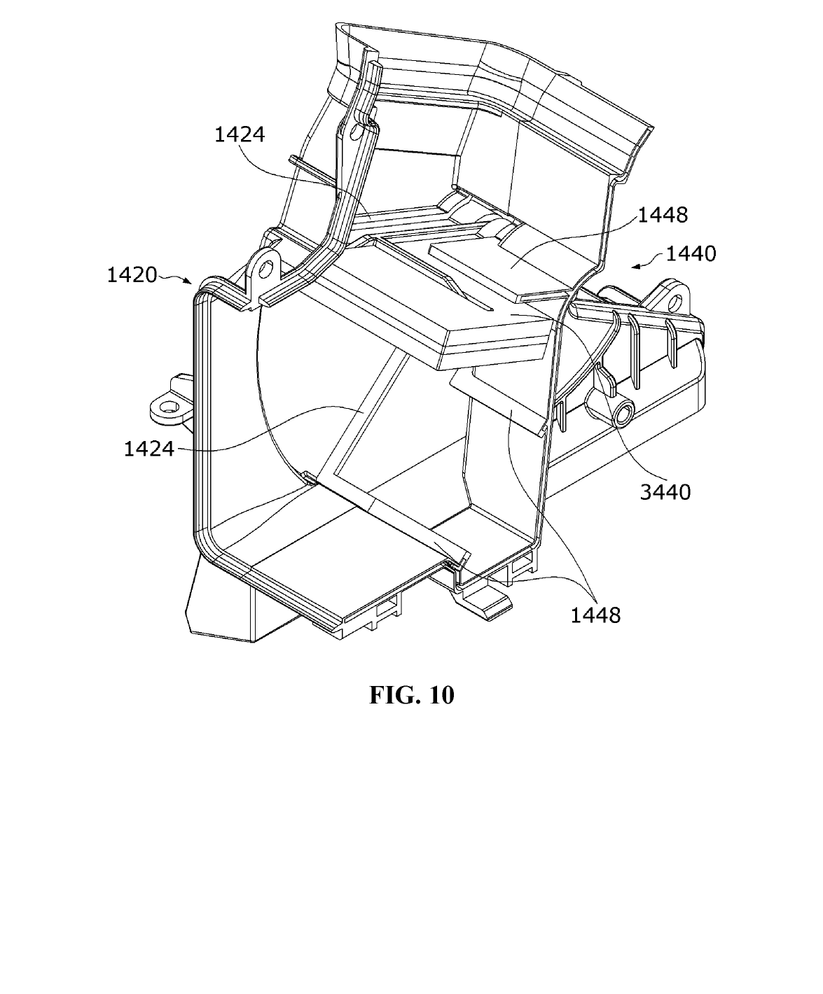

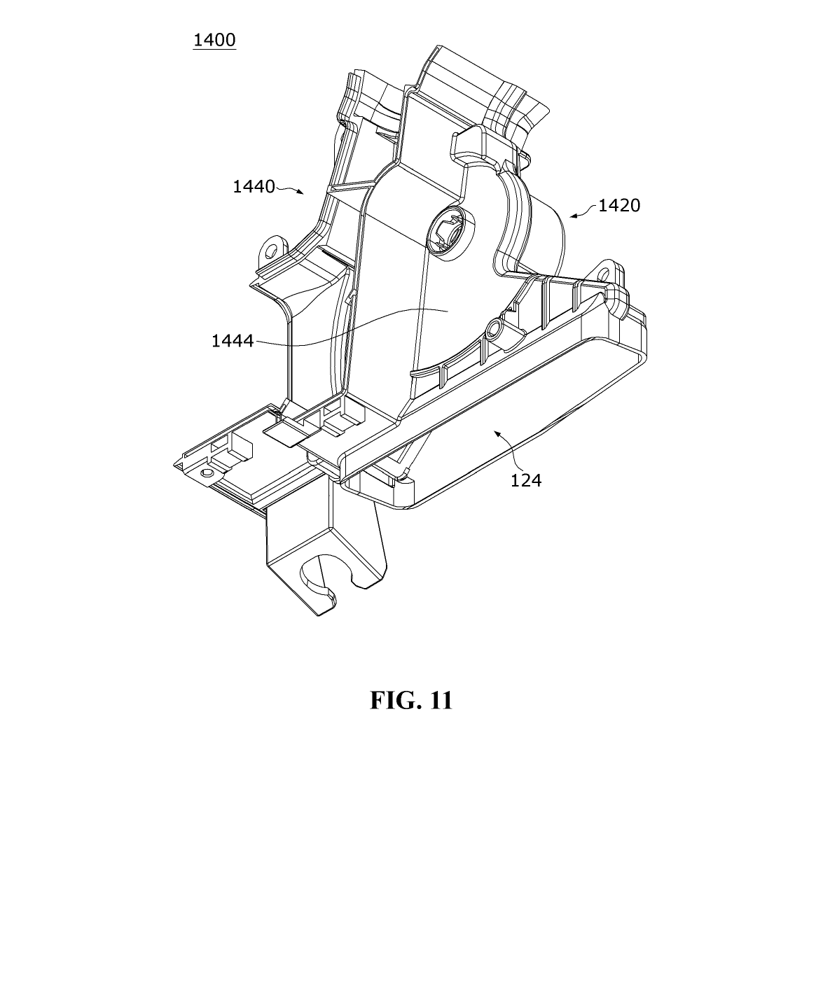

FIG. 9 is an exploded perspective view illustrating the second case unit of the housing, FIG. 10 is a view illustrating the second case unit to which a second door is coupled, and FIG. 11 is a view illustrating a second discharge part formed in the second case unit.

Referring to FIGS. 4 and 9 to 11, with the separator 2000, the second case unit 1400 may form a second inner space IS2 and a second outer space OS2 (see FIG. 2). The second case unit 1400 may include a third case frame 1420 and a fourth case frame 1440.

The third case frame 1420 may be disposed to be spaced apart from the separator 2000. With the fourth case frame 1440, the third case frame 1420 may form a portion of the housing 1000. The third case frame 1420 may be a component disposed at an outermost side of the vehicle air-conditioning apparatus 1. The third case frame 1420 may include a 2-1 accommodation part 1422 and a 2-1 stopper part 1424.

The 2-1 accommodation part 1422 may be formed on the third case frame 1420. The 2-1 accommodation part 1422 may rotatably support a second shaft part 3444 of a second door unit 3400 which will be described below. The 2-1 accommodation part 1422 may be disposed at one side (outside) of the second partition plate 1442 based on the second partition plate 1442 of the fourth case frame 1440 in a state in which the third case frame 1420 is coupled to the fourth case frame 1440.

The 2-1 stopper part 1424 may be disposed on a surface of the third case frame 1420 which is not exposed to the outside. The 2-1 stopper part 1424 may be a plurality of protruding parts protruding from the third case frame 1420. The plurality of protruding parts forming the 2-1 stopper part 1424 may block movement of a second door 3440, which will be described below, to prevent the second door 3440 from rotating at a predetermined angle or more. That is, the 2-1 stopper part 1424 may be disposed on a rotation path of the second door 3440 which will be described below.

The fourth case frame 1440 may be coupled to the third case frame 1420. The fourth case frame 1440 may be disposed between the third case frame 1420 and the separator 2000 and may connect the third case frame 1420 and the separator 2000. The fourth case frame 1440 may include the second partition plate 1442, a second side plate 1444, a 2-2 accommodation part 1446, and a 2-2 stopper part 1448.

The second partition plate 1442 may isolate the second inner space IS2 from the second outer space OS2 which are formed by the second case unit 1400 and the separator 2000 (see FIG. 2). The second partition plate 1442 may be one of components forming a second inlet part 240, which will be described below, and a 2-2 discharge part 144.

The second side plate 1444 may have a shape bent from the second partition plate 1442 and may form the second outer space OS2 with the second partition plate 1442 and the separator 2000 (see FIG. 2). The second side plate 1444 may shield an open portion of the third case frame 1420.

The 2-2 accommodation part 1446 may be formed on the second side plate 1444. The 2-2 accommodation part 1446 may be disposed to be colinear with the 2-1 accommodation part 1422 disposed on the third case frame 1420. The 2-2 accommodation part 1446 may rotatably support the second shaft part 3444 of the second door unit 3400 which will be described below. As illustrated in FIG. 11, the 2-2 accommodation part 1446 may be disposed at one side (outside) of the second partition plate 1442 based on the second partition plate 1442 of the fourth case frame 1440.

The 2-2 stopper part 1448 may be disposed on the second partition plate 1442. The 2-2 stopper part 1448 may be a plurality of protruding parts protruding from the second partition plate 1442. The plurality of protruding parts forming the 2-2 stopper part 1448 may block the movement of the second door 3440, which will be described below, to prevent the second door 3440 from rotating at the predetermined angle or more. That is, the 2-2 stopper part 1448 may be disposed on the rotation path of the second door 3440 which will be described below. In addition, in a state in which the fourth case frame 1440 is coupled to the third case frame 1420, the 2-2 stopper part 1448 may be disposed to be colinear with the 2-1 stopper part.

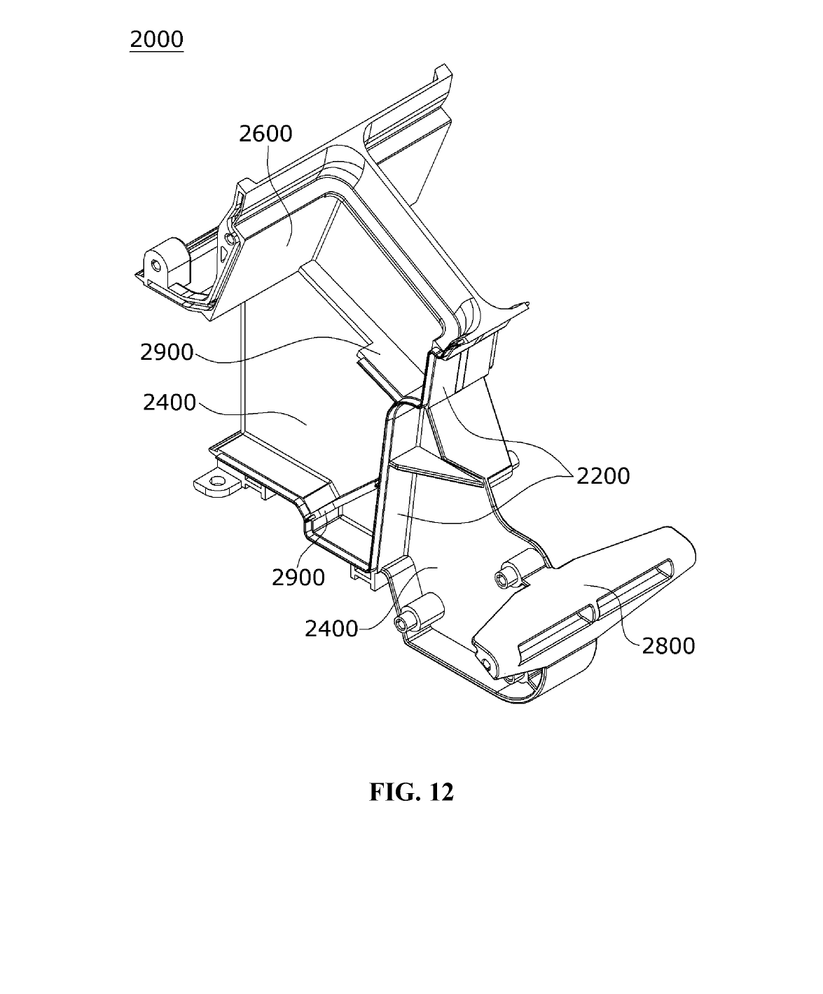

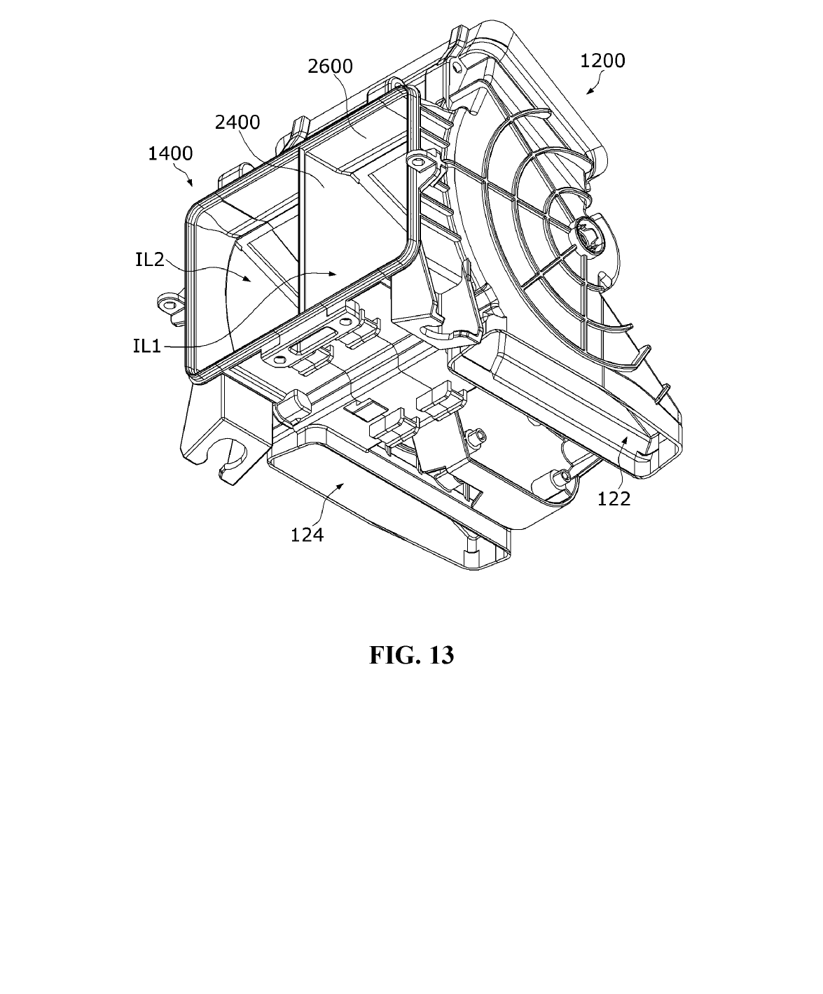

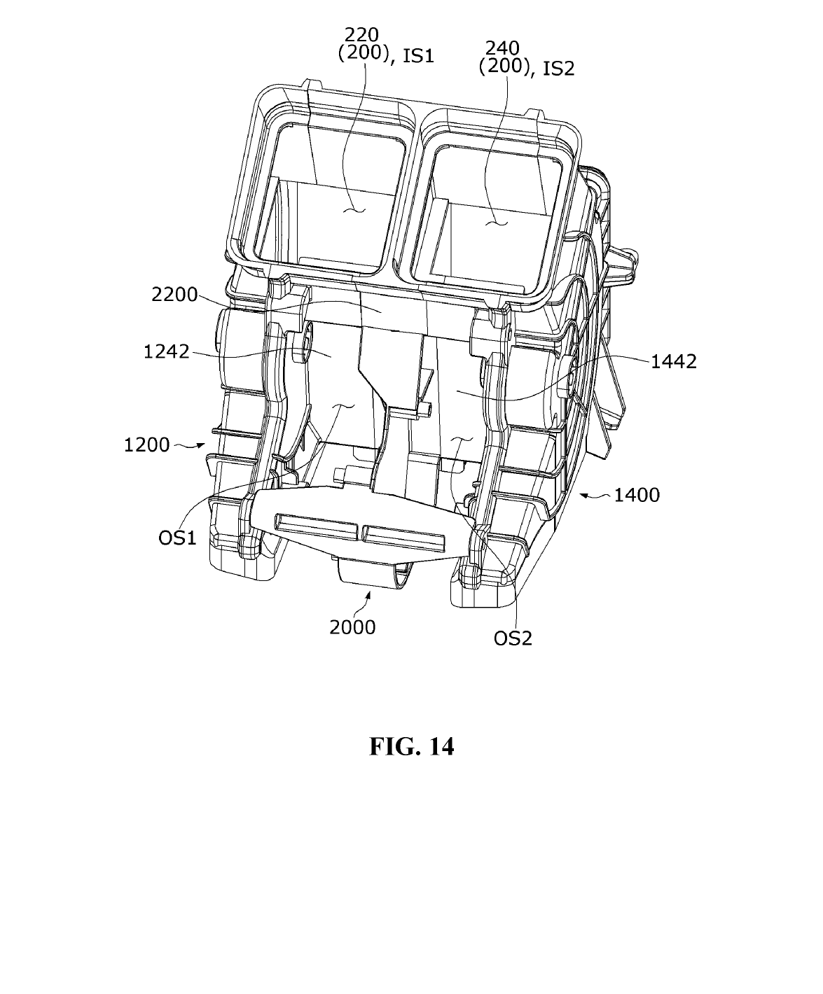

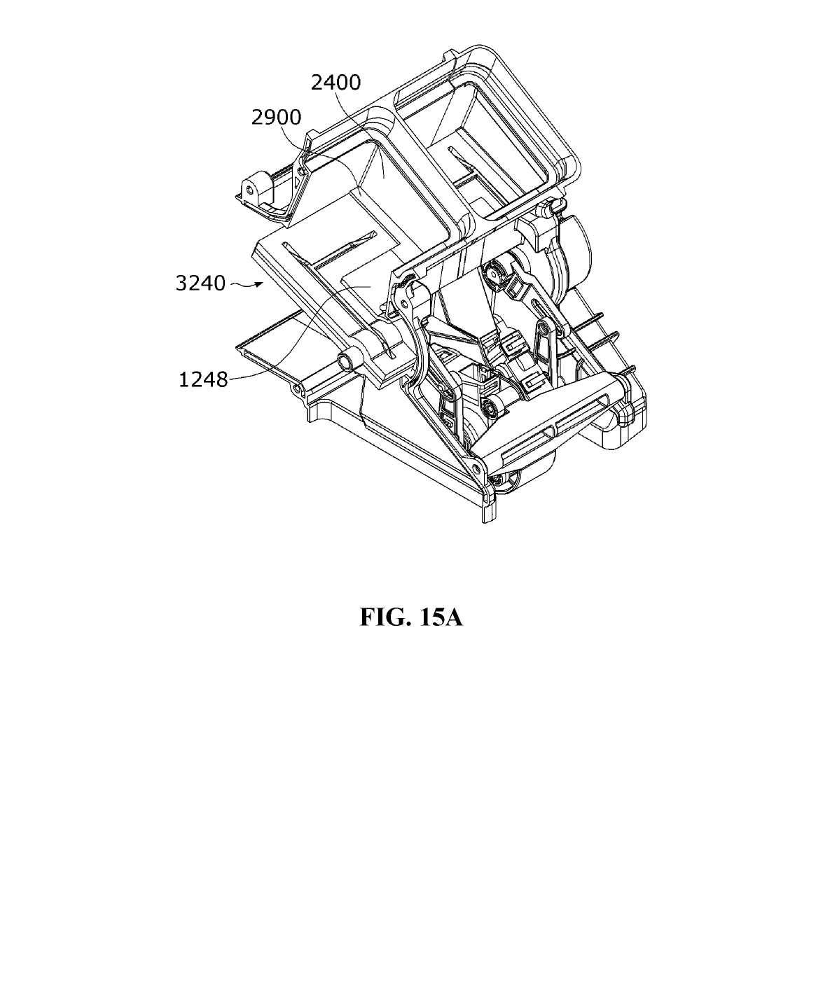

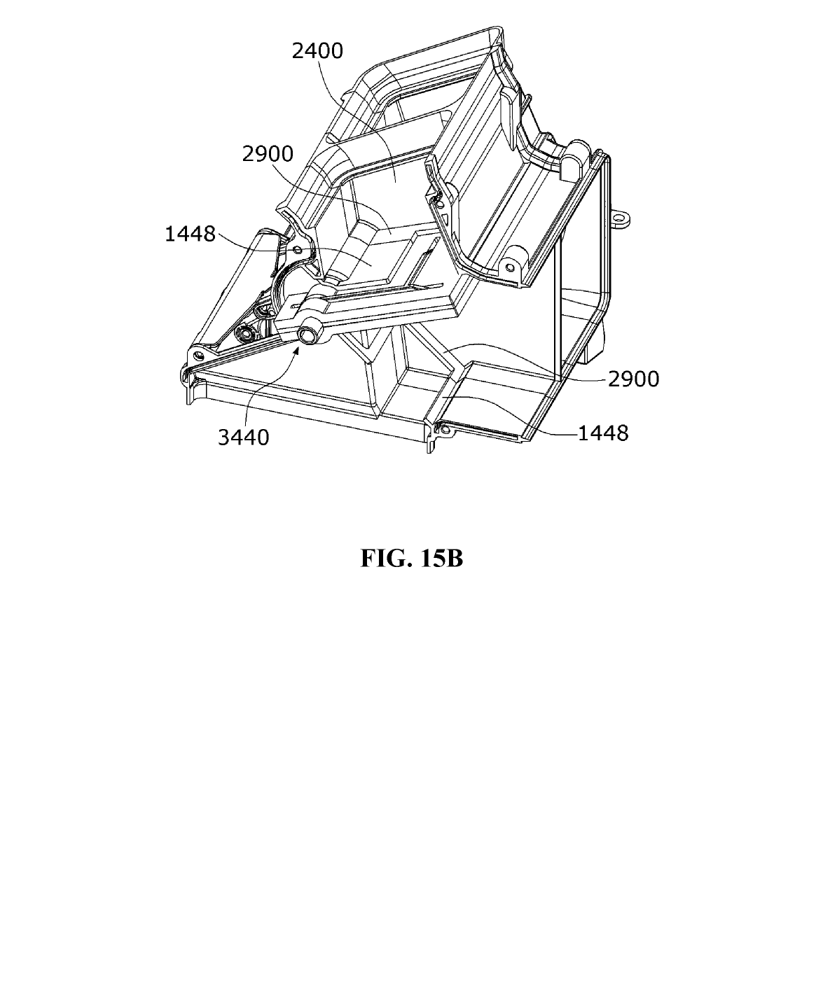

FIG. 12 is a perspective view illustrating the separator, and FIG. 13 is a view illustrating the first inlet part and the second inlet part formed by the first case unit, the second case unit, and the separator. FIG. 14 is a view illustrating the first outer space and the second outer space formed by the first case unit, the second case unit, and the separator, and FIGS. 15A and 15B are views illustrating a third stopper part of the separator.

Referring to FIGS. 4 and 12 to 15B, the separator 2000 may be disposed between the first case unit 1200 and the second case unit 1400 of the housing 1000. The separator 2000 may include a third partition plate 2200, a fourth partition plate 2400, a shielding plate 2600, a fixing protrusion 2800, and a third stopper part 2900.

The third partition plate 2200 may be disposed between the first case unit 1200 and the second case unit 1400 of the housing 1000. As illustrated in FIG. 14, with the second case frame 1240 of the first case unit 1200 and the fourth case frame 1440 of the second case unit 1400, the third partition plate 2200 may serve as a partition wall which divides a space through which air moves and the other space.

The fourth partition plate 2400 may be disposed to intersect the third partition plate 2200 and disposed between the first partition plate 1242 of the first case unit 1200 and the second partition plate 1442 of the second case unit 1400.

In addition, the fourth partition plate 2400 may support the third partition plate 2200 and divide a space formed between the first case unit 1200 and the second case unit 1400 of the housing 1000. In this case, the fourth partition plate 2400 may have a shape protruding from both surfaces of the third partition plate 2200.

The shielding plate 2600 may be connected to the fourth partition plate 2400. The shielding plate 2600 may be disposed in a direction intersecting the fourth partition plate 2400. The shielding plate 2600 may be disposed to be spaced apart from the third partition plate 2200 with the fourth partition plate 2400 interposed therebetween. As illustrated in FIGS. 13 and 14, the shielding plate 2600 may be disposed between the first case unit 1200 and the second case unit 1400 of the housing 1000. Accordingly, the shielding plate 2600 may shield an open portion of the housing 1000.

The shielding plate 2600 may form an air flow path. In addition, with the housing 1000 and the fourth partition plate 2400, the shielding plate 2600 may form a first inlet part IL1 and a second inlet part IL2 through which air is introduced into the housing 1000.

The fixing protrusion 2800 may be disposed on the fourth partition plate 2400. The fixing protrusion 2800 may be coupled to the first case unit 1200 and the second case unit 1400 of the housing 1000 to fix the separator 2000 to the housing 1000. Since the fixing protrusion 2800 is coupled to the first case unit 1200 and the second case unit 1400, shaking of the first case unit 1200 and the second case unit 1400 may be reduced to improve air discharging stability of the vehicle air-conditioning apparatus 1. In addition, the fixing protrusion 2800 may support the first case unit 1200 and the second case unit 1400 to improve stiffness of the first case unit 1200 and the second case unit 1400.

As illustrated in FIGS. 15A and 15B, the third stopper part 2900 may be disposed on the fourth partition plate 2400. The third stopper part 2900 may be disposed in the first inner space IS1 and the second inner space IS2 formed by the housing 1000 and the separator 2000. The third stopper part 2900 may protrude from both surfaces of the fourth partition plate 2400. In a state in which the separator 2000 is coupled to the first case unit 1200 and the second case unit 1400, the third stopper part 2900 may be disposed to be colinear with the 1-1 stopper part 1224 and the 1-2 stopper part 1248 of the first case unit 1200 and the 2-1 stopper part 1424 and the 2-2 stopper part 1448 of the second case unit 1400 of the housing 1000.

The third stopper part 2900 may block movement of the first door 3240 and the second door 3440, which will be described below, to prevent the first door 3240 and the second door 3440 from rotating at predetermined angles or more. That is, the third stopper part 2900 may be disposed on the rotation paths of the first door 3240 and the second door 3440 which will be described below.

In the vehicle air-conditioning apparatus 1 according to the embodiment of the present invention, the housing 1000 and the separator 2000 may form a discharge unit part 100 which discharges air. The discharge unit part 100 may include a first discharge part 120 which discharges air toward a lower side of the housing 1000 and the separator 2000 and a second discharge part 140 which discharges air toward an upper side of the housing 1000 and the separator 2000.

First, the first discharge part 120 may include a 1-1 discharge part 122 which is formed by the first case unit 1200 and discharges air to the lower side as illustrated in FIGS. 3 and 8 and a 1-2 discharge part 124 which is formed by the second case unit 1400 and discharges air to the upper side as illustrated in FIGS. 3 and 11.

The 1-1 discharge part 122 is a part which discharges air to the outside of the housing 1000, and the 1-1 discharge part 122 may guide the air in a moving direction to move the air toward a bottom surface of the rear seat region of the vehicle. The second discharge part 124 is a part which discharges air to the outside of the housing 1000, and the second discharge part 124 may guide the air in a moving direction to move the air toward the bottom surface of the rear seat region of the vehicle.

Next, as illustrated in FIG. 13, the second discharge part 140 may include the 2-1 discharge part 142 formed by the first case unit 1200 and the separator 2000 together and the 2-2 discharge part 144 formed by the second case unit 1400 and the separator 2000.

In addition, as illustrated in FIG. 13, in the vehicle air-conditioning apparatus 1, the housing 1000 and the separator 2000 may form an inlet part 200. The inlet part 200 includes the first inlet part 220 and the second inlet part 240, and the first inlet part 220 and the second inlet part 240 have spaces divided by the fourth partition plate 2400 of the separator 2000.

In addition, as illustrated in FIG. 14, the separator 2000 may form the first inner space IS1 and the first outer space OS1 with the first case unit 1200 and the second inner space IS2 and the second outer space OS2 with the second case unit 1400. In this case, the first inner space IS1 and the first outer space OS1 may be spaced apart from the second inner space IS2 and the second outer space OS2 by the separator 2000.

More specifically, the first inner space IS1 and the first outer space OS1 may be spaced apart from the second inner space IS2 and the second outer space OS2 by the first partition plate 1242 of the first case unit 1200, the second partition plate 1442 of the second case unit 1400, and the third partition plate 2200 of the separator 2000. This is to allow the first door unit 3200 and the second door unit 3400, which will be described below, to individually move.

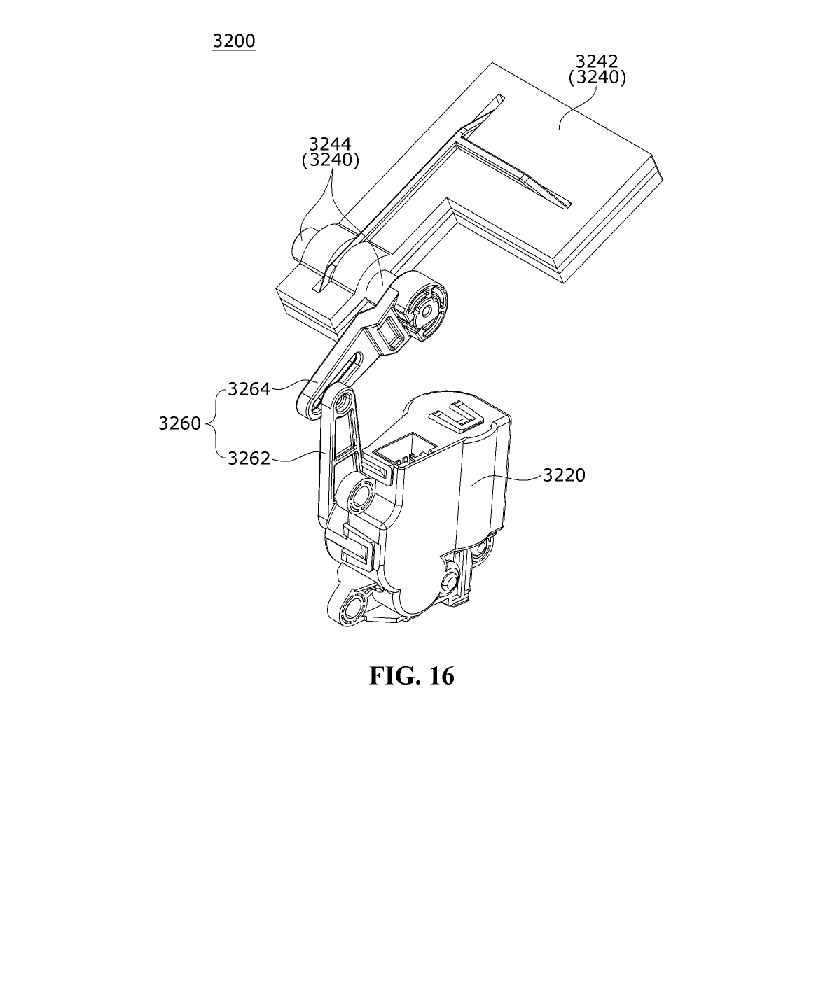

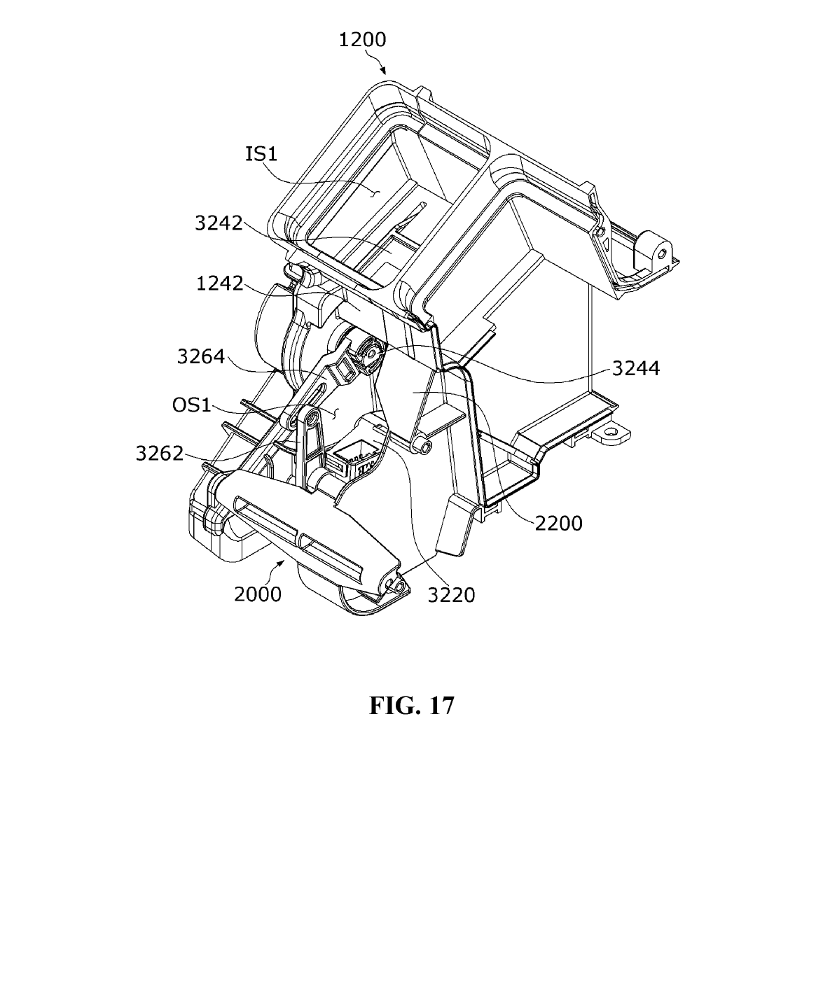

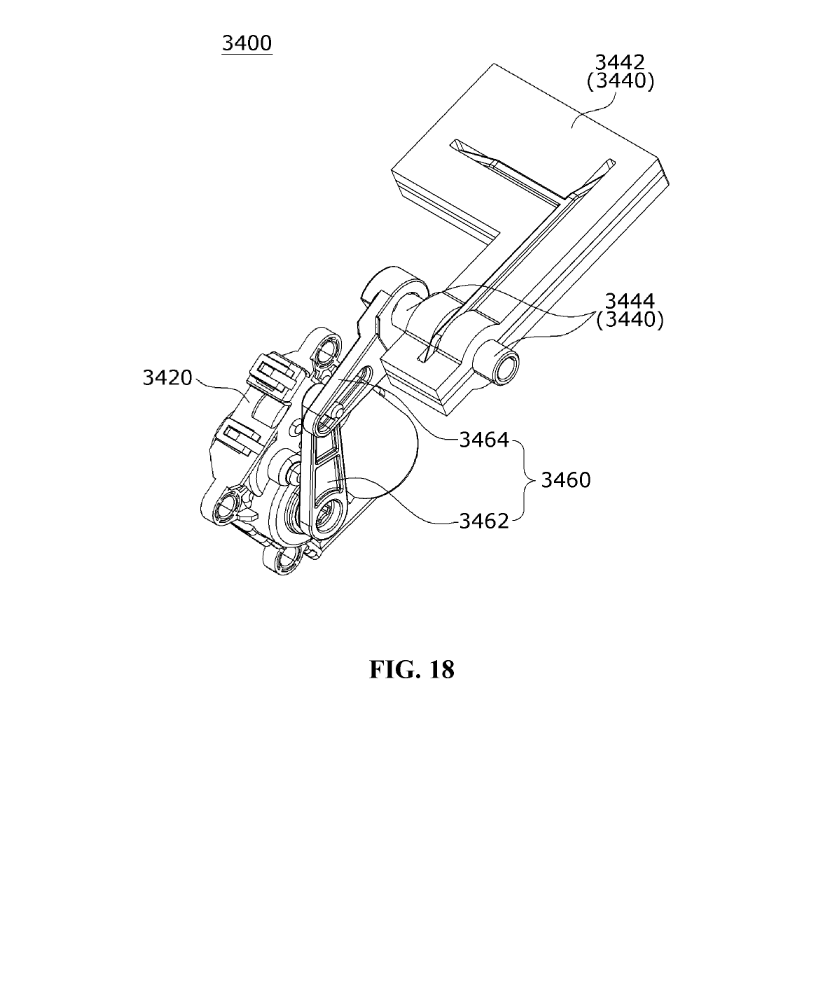

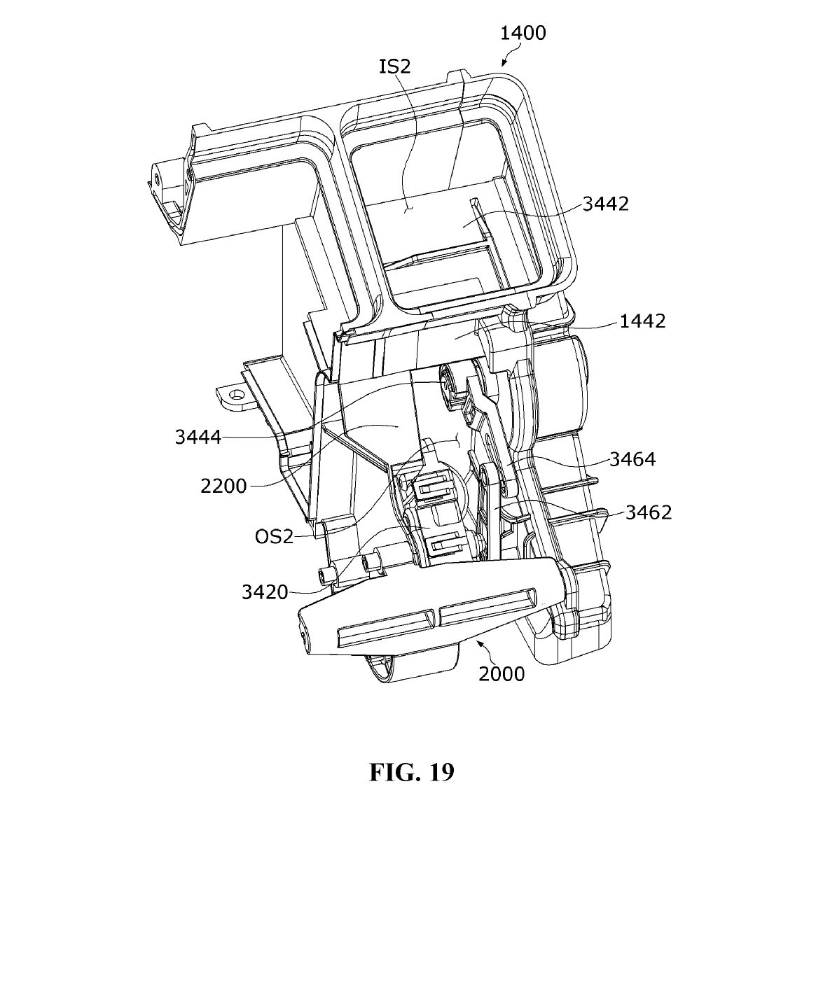

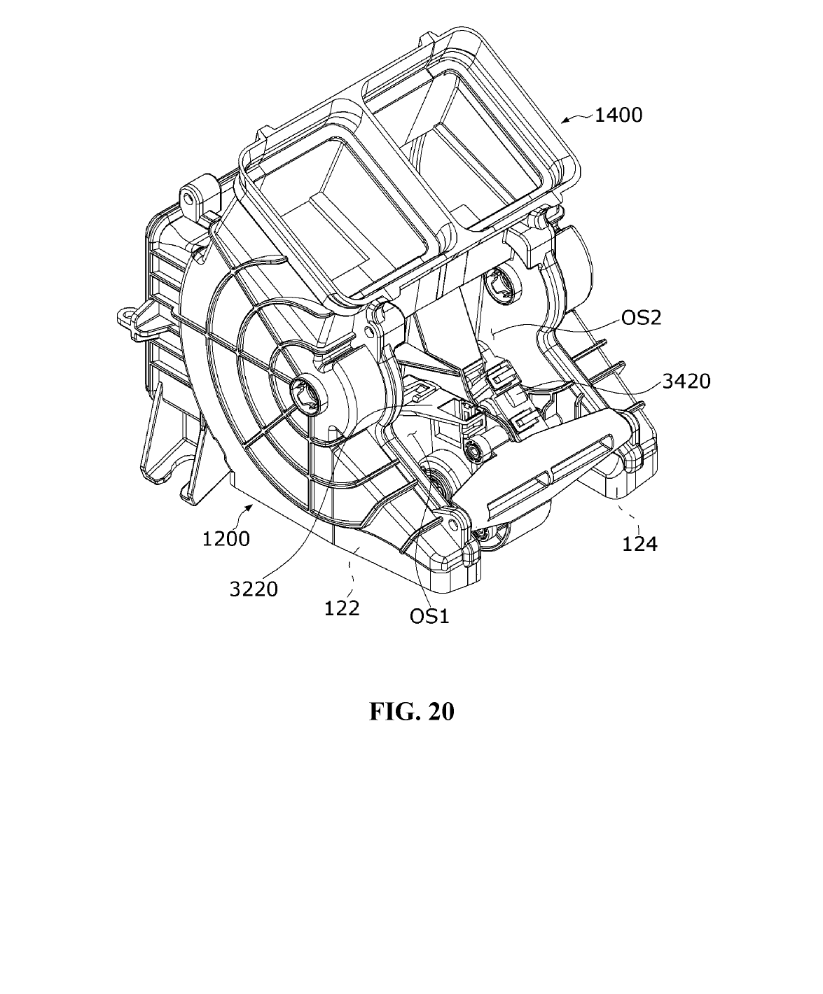

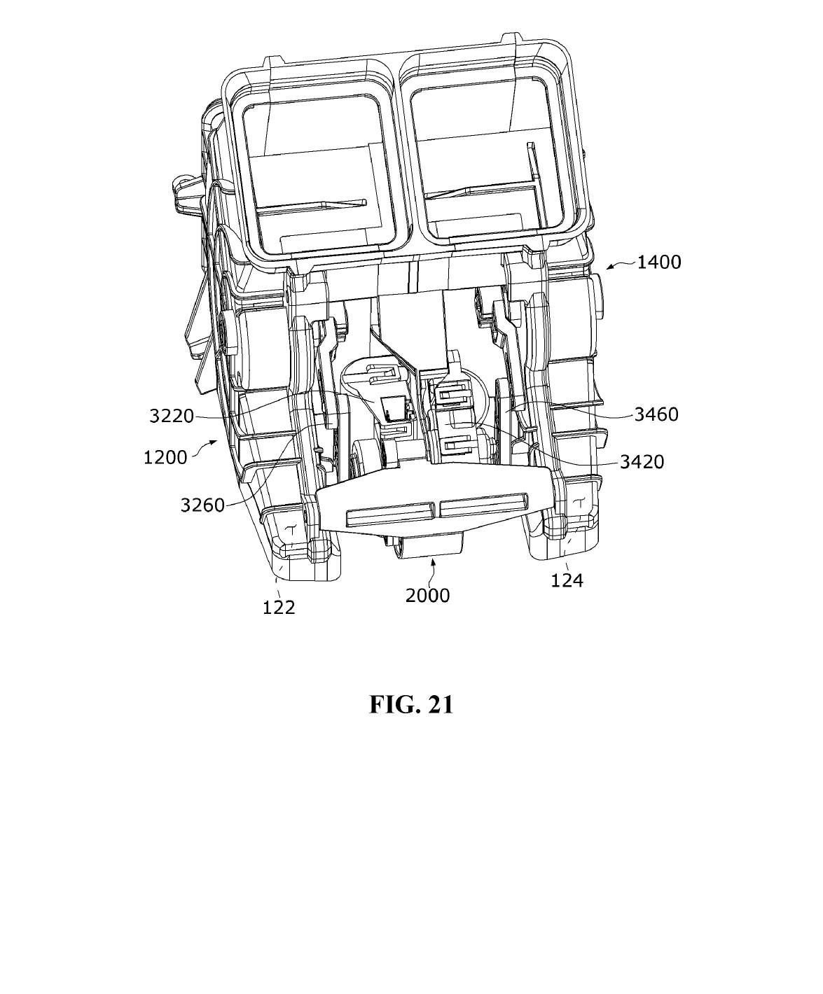

FIG. 16 is a perspective view illustrating the first door unit, and FIG. 17 is a view illustrating the first door unit disposed on the housing and the separator. FIG. 18 is a perspective view illustrating the second door unit, and FIG. 19 is a view illustrating the second door unit disposed on the housing and the separator. FIG. 20 is a view illustrating a first actuator 3200 and a second actuator disposed in the first outer space and the second outer space, and FIG. 21 is a view illustrating the first door unit and the second door unit which are disposed on the housing and the separator.

The door unit 3000 may be connected to each of the case units and determine a moving direction of air which moves along the case unit. The door unit 3000 may include the first door unit 3200 and the second door unit 3400.

Referring to FIGS. 4, 16, and, 17, the first door unit 3200 may be disposed at one side of the separator 2000 based on the separator 2000 coupled to the housing 1000. The first door unit 3200 may include the first actuator 3220, the first door 3240, and a first lever 3260. The components of the first door unit 3200 may be disposed in a left region of the separator 2000 based on FIGS. 16 and 17.

The first actuator 3220 may be coupled to the separator 2000. More specifically, the first actuator 3220 may be coupled to the fourth partition plate 2400 of the separator 2000. In addition, the first actuator 3220 may be disposed outside the first partition plate 1242 and the third partition plate 2200 based on the first partition plate 1242 of the second case frame 1240 of the first case unit 1200 of the housing 1000 and the third partition plate 2200 of the separator 2000. The first actuator 3220 may receive power from the outside and generate power.

The first door 3240 may be disposed in the first inner space IS1 formed by the first case unit 1200 of the housing 1000 and the separator 2000 and rotatably coupled to the first case unit 1200. The first door 3240 may be disposed between the first case unit 1200 and the separator 2000. The first door 3240 may be disposed in the space formed by the first case unit 1200 of the housing 1000 and the separator 2000 and selectively open or close a partial region of the space. In this case, the first door 3240 may be disposed inside the first partition plate 1242 and the third partition plate 2200 based on the first partition plate 1242 of the second case frame 1240 of the first case unit 1200 of the housing 1000 and the third partition plate 2200 of the separator 2000.

The first door 3240 may include a first opening and closing part 3242 which may come into contact with the first case unit 1200 and the separator 2000 and the first shaft part 3244 which protrudes from a portion of the first opening and closing part 3242 and is rotatably accommodated in the1-1 accommodation part 1222 and the 1-2 accommodation part 1246 of the first case unit 1200 of the housing 1000. In this case, the first shaft part 3244 may pass through the 1-2 accommodation part 1246 of the first case unit 1200 and protrude to be exposed to the outside of the first case unit 1200 as illustrated in FIG. 16.

The first lever 3260 may be dispose in the first outer space OS1 formed by the first case unit 1200 of the housing 1000 and the separator 2000 and may connect the first actuator 3220 and the first door 3240. The first lever 3260 may include a 1-1 lever plate 3262 rotatably connected to the first actuator 3220 and a 1-2 lever plate 3264 which connects the first door 3240 and the 1-1 lever plate 3262. More specifically, the 1-2 lever plate 3264 may be connected to the first shaft part 3244 of the first door 3240.

Referring to FIGS. 4, 18, and 19, the second door unit 3400 may be disposed at the other side which is opposite to one side of the separator 2000 based on the separator 2000 coupled to the housing 1000. The second door unit 3400 may include a second actuator 3420, the second door 3440, and a second lever 3460. The components of the second door unit 3400 may be disposed in a right region of the separator 2000 based on FIGS. 18 and 19.

The second actuator 3420 may be coupled to the separator 2000. More specifically, the second actuator 3420 may be coupled to the fourth partition plate 2400 of the separator 2000. In addition, the second actuator 3420 may be disposed outside the second partition plate 1442 and the third partition plate 2200 based on the second partition plate 1442 of the fourth case frame 1440 of the second case unit 1400 of the housing 1000 and the third partition plate 2200 of the separator 2000. The second actuator 3420 may receive power from the outside and generate power.

The second door 3440 may be disposed in the second inner space IS2 formed by the second case unit 1400 of the housing 1000 and the separator 2000 and rotatably coupled to the second case unit 1400. The second door 3440 may be disposed between the second case unit 1400 and the separator 2000. The second door 3440 may be disposed in a space formed by the second case unit 1400 of the housing 1000 and the separator 2000 and may selectively open or close a partial region of the space. In this case, the second door 3440 may be disposed inside the second partition plate 1442 and the third partition plate 2200 based on the second partition plate 1442 of the fourth case frame 1440 of the second case unit 1400 of the housing 1000 and the third partition plate 2200 of the separator 2000.

The second door 3440 may include a second opening and closing part 3442 which may come into contact with the second case unit 1400 and the separator 2000 and the second shaft part 3444 which protrudes from a portion of the second opening and closing part 3442 and is rotatably accommodated in the 2-1 accommodation part 1422 and the 2-2 accommodation part 1446 of the second case unit 1400 of the housing 1000. In this case, the second shaft part 3444 may pass through the 2-2 accommodation part 1446 of the second case unit 1400 and protrude to be exposed to the outside of the second case unit 1400 as illustrated in FIG. 19.

The second lever 3460 may be disposed in the second outer space OS2 formed by the second case unit 1400 of the housing 1000 and the separator 2000 and connect the second actuator 3420 and the second door 3440. The second lever 3460 may include a 2-1 lever plate 3462 rotatably connected to the second actuator 3420 and a 2-2 lever plate 3464 which connects the second door 3440 and the 2-1 lever plate 3462. More specifically, the 2-2 lever plate 3464 may be connected to the second shaft part 3444 of the second door 3440.

Referring to FIG. 20, the first actuator 3220 of the first door unit 3200 may be disposed in the first outer space OS1, and the second actuator 3420 of the second door unit 3400 may be disposed in the second outer space OS2. In this case, the first outer space OS1 and the second outer space OS2 are formed inside the first case unit 1200 and the second case unit 1400 of the housing 1000. In addition, the actuators 3220 and 3420 may be disposed to be spaced apart from the first case unit 1200 and the second case unit 1400 and disposed inside the first case unit 1200 and the second case unit 1400 while coupled to outer surfaces (fourth partition plate 2400) of the separator 2000.

The fact that the first actuator 3220 is disposed in the first outer space and the second actuator 3420 is disposed in the second outer space OS2 as described above means that the first actuator 3220 and the second actuator 3420 are not disposed outside the housing 1000.

This means that an air flow area formed by the housing 1000 and the separator 2000 is not reduced by the actuators because the actuators are not disposed outside the housing 1000. Accordingly, since the same amount of air may be discharged through the 2-1 discharge part 142 and the 2-2 discharge part 144 formed by the housing 1000 and the separator 2000, the rear seat region of the vehicle can be uniformly cooled or heated.

In addition, since the first actuator 3220 of the first door unit 3200 is disposed in the first outer space OS1, and the second actuator 3420 of the second door unit 3400 is disposed in the second outer space OS2, the actuator is not disposed outside the housing 1000, and thus an inconvenience of installing the vehicle air-conditioning apparatus 1 of the present invention in a space between the vehicle and the passenger seat due to the actuators can be relieved.

Referring to FIG. 21, the first actuator 3220 of the first door unit 3200 may be disposed close to the separator 2000, the first lever 3260 may be disposed close to the first case unit 1200, the second actuator 3420 of the second door unit 3400 may be disposed close to the separator 2000, and the second lever 3460 may be disposed close to the second case unit 1400.

This is to prevent an air discharge amount from being ununiform due to shaking of the housing 1000 caused by vibration due to operation of the actuator in a state in which the actuator is coupled to the housing 1000.

In addition, the reason of the above-described structure is to prevent discharge areas of the 1-1 discharge part 122 and the 1-2 discharge part 124 from being reduced due to a change in arrangement direction of the doors when the levers are disposed on the separator 2000 and the actuators are disposed in the housing 1000. That is, the structure, in which the first actuator 3220 of the first door unit 3200 is disposed close to the separator 2000, the first lever 3260 is disposed close to the first case unit 1200, the second actuator 3420 of the second door unit 3400 is disposed close to the separator 2000, and the second lever 3460 is disposed close to the second case unit 1400, may prevent an amount of air discharged to a lower region of the rear seat of the vehicle from being reduced.

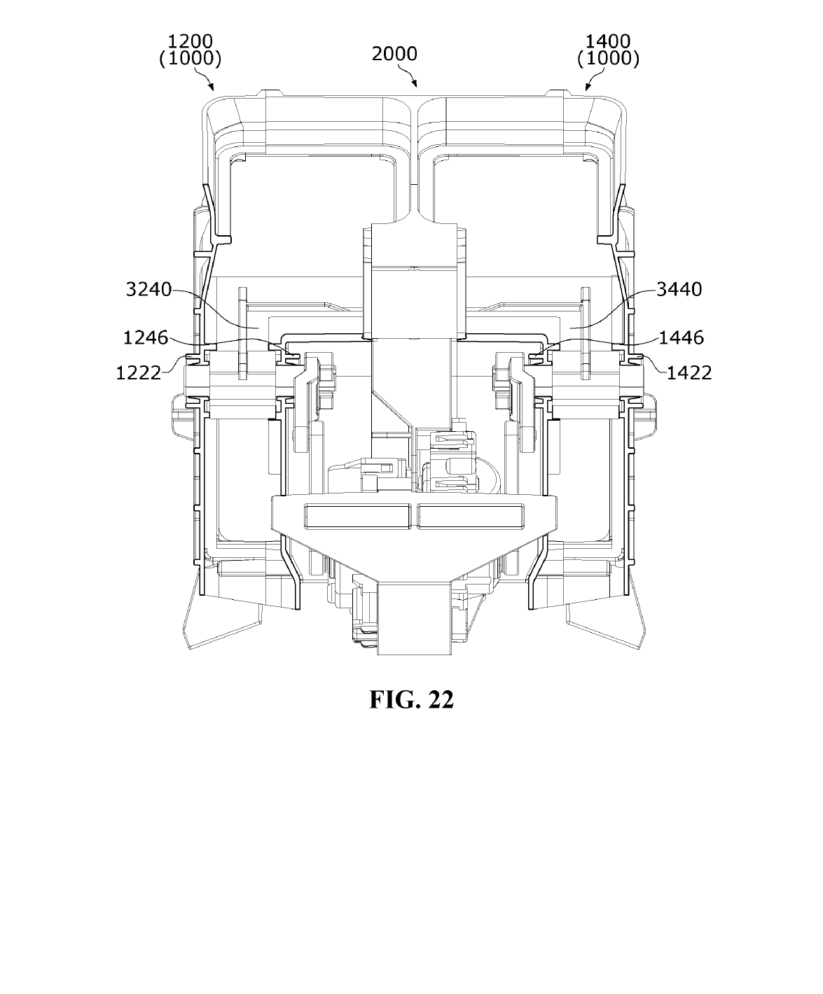

FIG. 22 is a front view illustrating the vehicle air-conditioning apparatus according to the embodiment of the present invention.

Referring to FIG. 22, a rotation center of the first door 3240 and a rotation center of the second door 3440 may be disposed to be colinear with each other. More specifically, the 1-1 accommodation part 1222 and the 1-2 accommodation part 1246 of the first case unit 1200 of the housing 1000 may be disposed to be colinear with each other, and the 2-1 accommodation part 1422 and the 2-2 accommodation part 1446 of the second case unit 1400 of the housing 1000 may be disposed to be colinear with each other.

This may mean that, when the first door unit 3200 and the second door unit 3400 operate at the same time, the first door 3240 and the second door 3440 may equally rotate at the same time to equally open or close an air flow space formed by the housing 1000 and the separator 2000. That is, the structure illustrated as in FIG. 22 may secure the same discharge amount to have an effect of uniformly cooling or heating the rear seat region of the vehicle.

In the vehicle air-conditioning apparatus 1 according to the embodiment of the present invention described above, an air discharge area can be secured through the actuators which are disposed in the plurality of spaces formed by the plurality of case units and the separator 2000, are coupled to the outer surfaces of the separator 2000, and generate the power for rotating the doors, and a difficulty in installation can be reduced. In addition, since conditioned air may be independently discharged to both side portions of the rear seat region of the vehicle through the separator 2000, a degree of air-conditioning freedom and a level of satisfaction of the vehicle rear seat region can be improved.

Hereinafter, a vehicle air-conditioning apparatus 2 according to another embodiment of the present invention will be described. When the vehicle air-conditioning apparatus 2 according to another embodiment of the present invention is described, components the same as those of the vehicle air-conditioning apparatus 1 according to the embodiment of the present invention will be assigned with the same reference numerals, and descriptions thereof will be omitted.

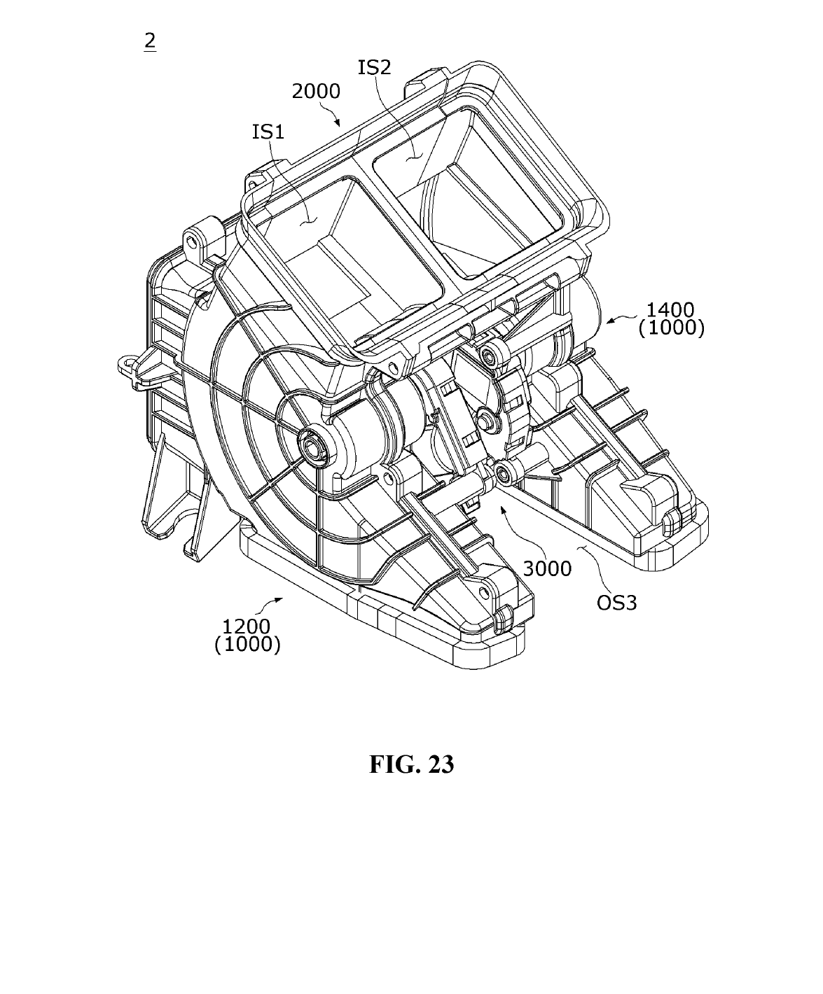

FIG. 23 is a perspective view illustrating the vehicle air-conditioning apparatus according to another embodiment of the present invention.

Referring to FIG. 23, the vehicle air-conditioning apparatus 2 according to another embodiment of the present invention may include a housing 1000, a separator 2000, and a door unit 3000.

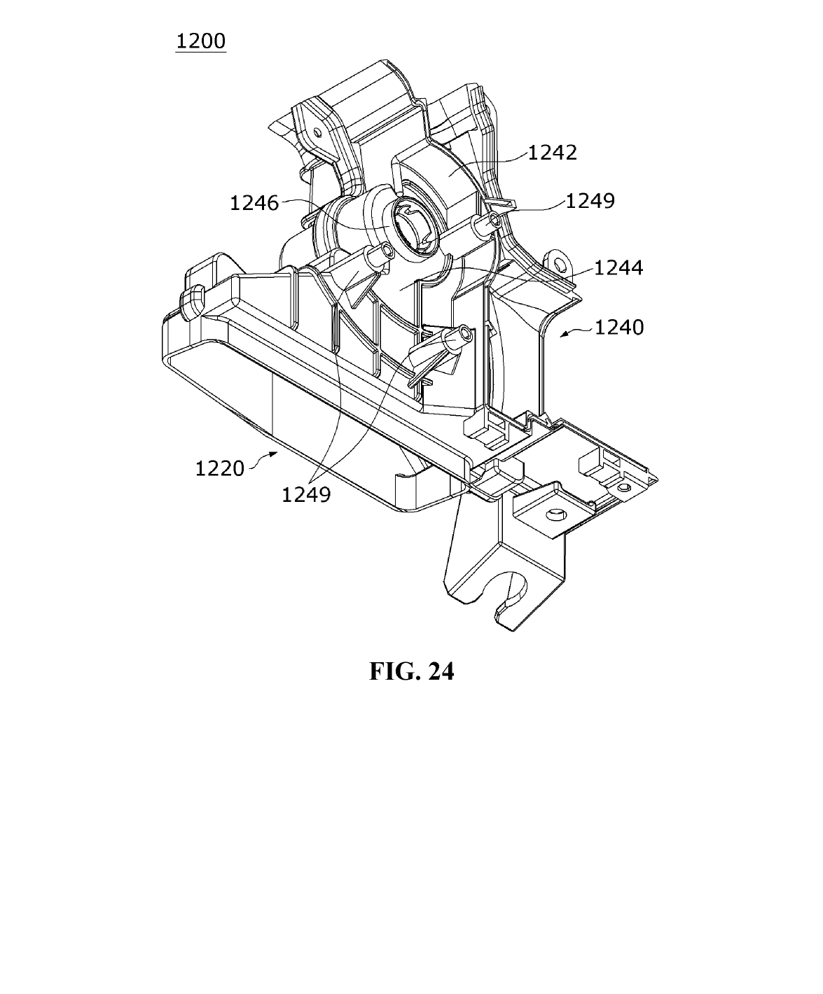

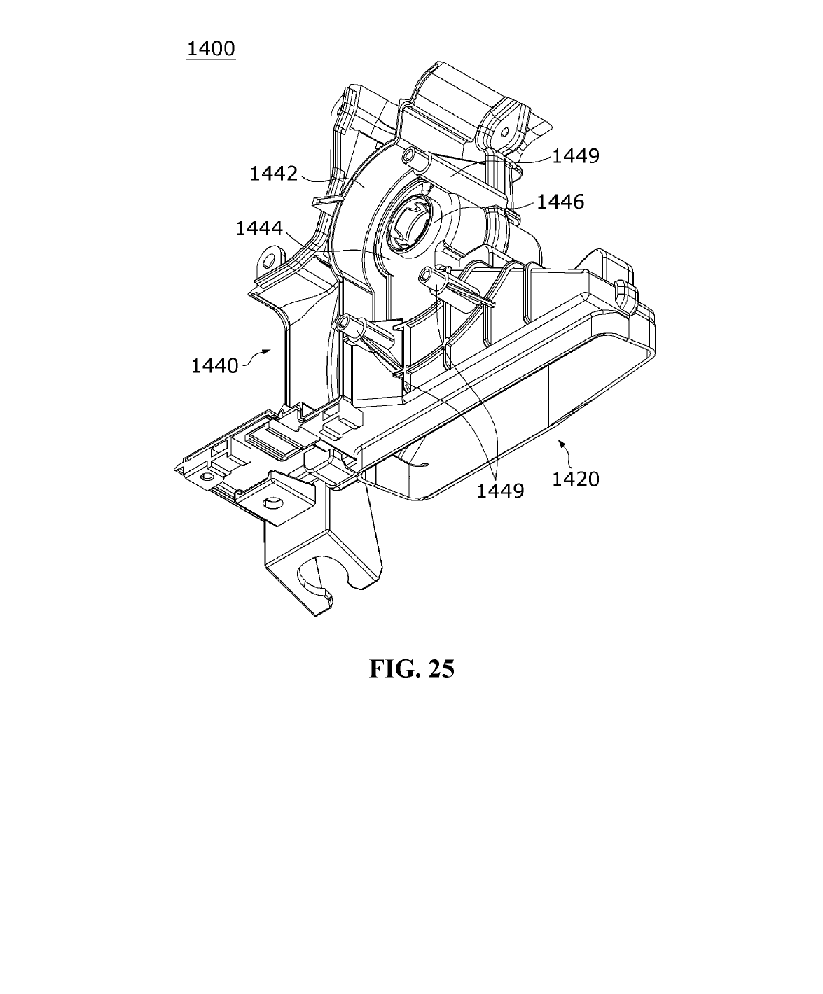

FIG. 24 is a view illustrating a first case unit, and FIG. 25 is a view illustrating a second case unit.

The housing 1000 may further include first coupling parts 1249 and second coupling parts 1449 in addition to the same components of the housing 1000 of the vehicle air-conditioning apparatus 1 according to the embodiment of the present invention.

Referring to FIGS. 23 and 24, the first coupling parts 1249 may be disposed on a second case frame 1240 of a first case unit 1200. Each of the first coupling parts 1249 may have a shape protruding toward a second case unit 1400 from an outer surface of the second case frame 1240. The first coupling parts 1249 may be disposed near an upper end portion of a 1-2 accommodation part 1246 and under the 1-2 accommodation part 1246 based on the 1-2 accommodation part 1246. However, the present invention is not limited thereto, and locations at which the first coupling parts 1249 are located may be changed at any time according to a shape of the second case frame 1240 or a shape of a first actuator 3220. In addition, the present embodiment in which three first coupling parts 1249 are provided is disclosed, but the present invention is not limited thereto.

The first coupling part 1249 may be provided in a hollow cylindrical shape. The first coupling parts 1249 may be coupled to 3-1 coupling parts 3222 of the first actuator 3220 to fix the first actuator 3220 to the second case frame 1240. In a state in which the 3-1 coupling parts 3222 of the first actuator 3220 are fixed to the first coupling parts 1249, when fixing members such as bolts are coupled to the first coupling parts 1249, the first actuator 3220 may be fixed to the first case unit 1200.

Referring to FIGS. 23 and 25, the second coupling parts 1449 may be disposed on a fourth case frame 1440 of the second case unit 1400. Each of the second coupling parts 1449 may have a shape protruding toward the first case unit 1200 from an outer surface of the fourth case frame 1440. The second coupling parts 1449 may be disposed near an upper end portion of a 2-2 accommodation part 1446 and under the 2-2 accommodation part 1446 based on the 2-2 accommodation part 1446. However, the present invention is not limited thereto, and locations at which the second coupling parts 1449 are located may be changed at any time according to a shape of the fourth case frame 1440 or a shape of a second actuator 3420. In addition, the present embodiment in which three second coupling parts 1449 are provided is disclosed, but the present invention is not limited thereto.

The second coupling part 1449 may be provided in a hollow cylindrical shape. The second coupling parts 1449 may be coupled to 4-1 coupling parts 3422 of the second actuator 3420 to fix the second actuator 3420 to the fourth case frame 1440. In a state in which the 4-1 coupling parts 3422 of the second actuator 3420 are fixed to the second coupling parts 1449, when fixing members such as bolts are coupled to the second coupling parts 1449, the second actuator 3420 may be fixed to the second case unit 1400.

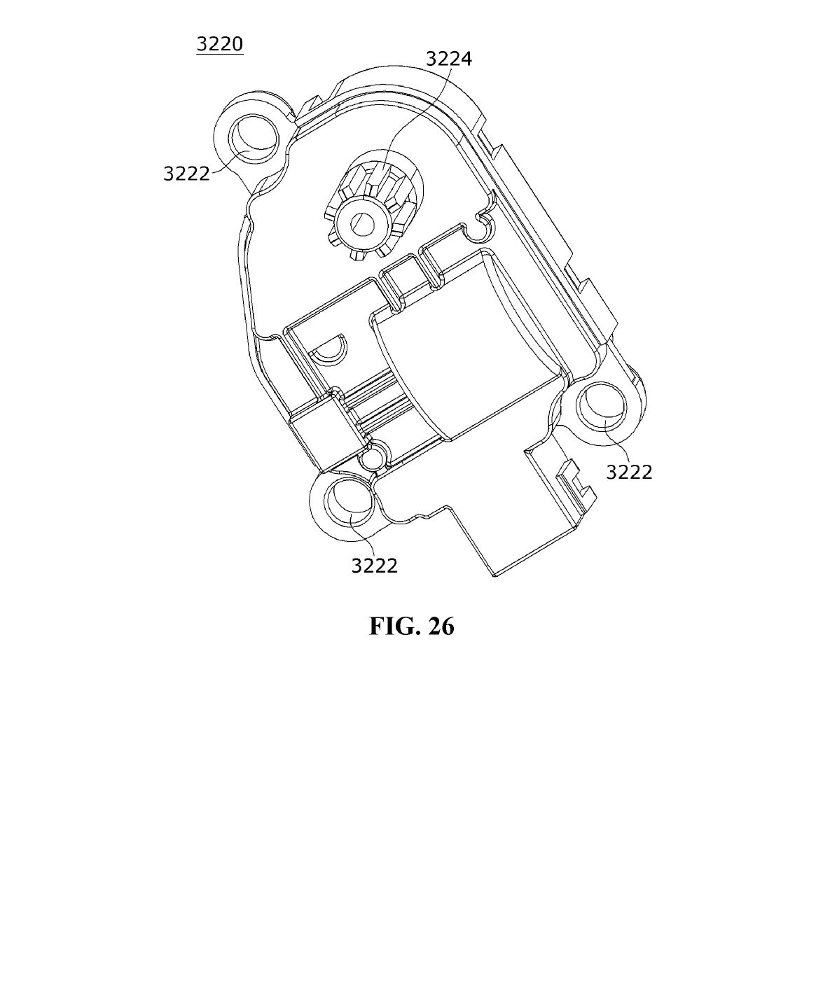

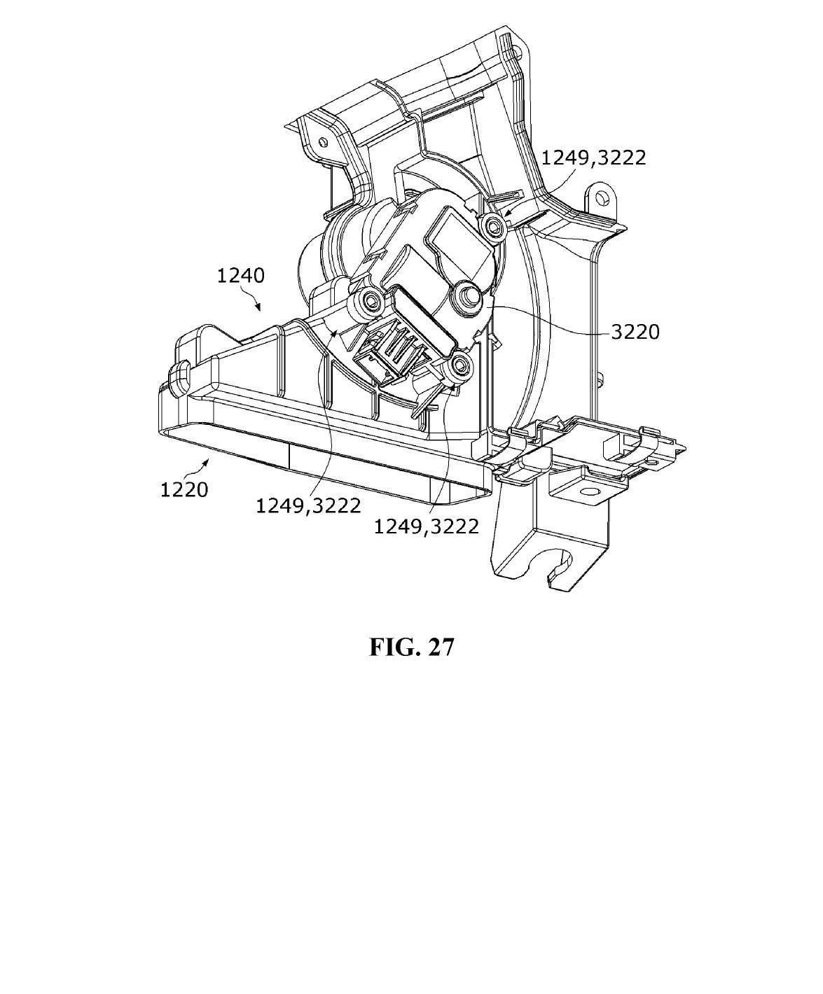

FIG. 26 is a view illustrating the first actuator, and FIG. 27 is a view illustrating the first actuator coupled to the first case unit.

Referring to FIGS. 26 and 27, the first actuator 3220 of a first door unit 3200 may include the 3-1 coupling parts 3222 and a 3-2 coupling part 3224.

The 3-1 coupling parts 3222 may be holes formed in the first actuator 3220. Each of the 3-1 coupling parts 3222 may have a size corresponding to an outer circumferential surface of the first coupling part 1249 of the second case frame 1240. The 3-1 coupling parts 3222 may be coupled to the first coupling parts 1249 of the second case frame 1240. The present embodiment in which three 3-1 coupling parts 3222 are provided is disclosed, but the present invention is not limited thereto. As the 3-1 coupling parts 3222 are coupled to the first coupling parts 1249 of the second case frame 1240, the first actuator 3220 may be fixed to the first case unit 1200.

The 3-2 coupling part 3224 may be a protrusion formed on the first actuator 3220. In this case, the first actuator 3220 may include a power generation part which receives power from the outside and generates power and a frame part which surrounds the power generation part to protect the power generation part. The 3-2 coupling part 3224 may be the protrusion which is connected to the power generation part of the first actuator 3220, passes through the frame part, and protrudes outward from the frame part, may be disposed on the frame part of the first actuator 3220, or may be a portion of the frame part which is connected to the power generation part and rotated along the power generation part. The 3-2 coupling part 3224 may be coupled to a first shaft part 3244. When the 3-2 coupling part 3224 is rotated by the power generated by the power generation part, the first shaft part 3244 may be rotated. Accordingly, the first door 3240 may be rotated about a rotation center, that is, the first shaft part 3244.

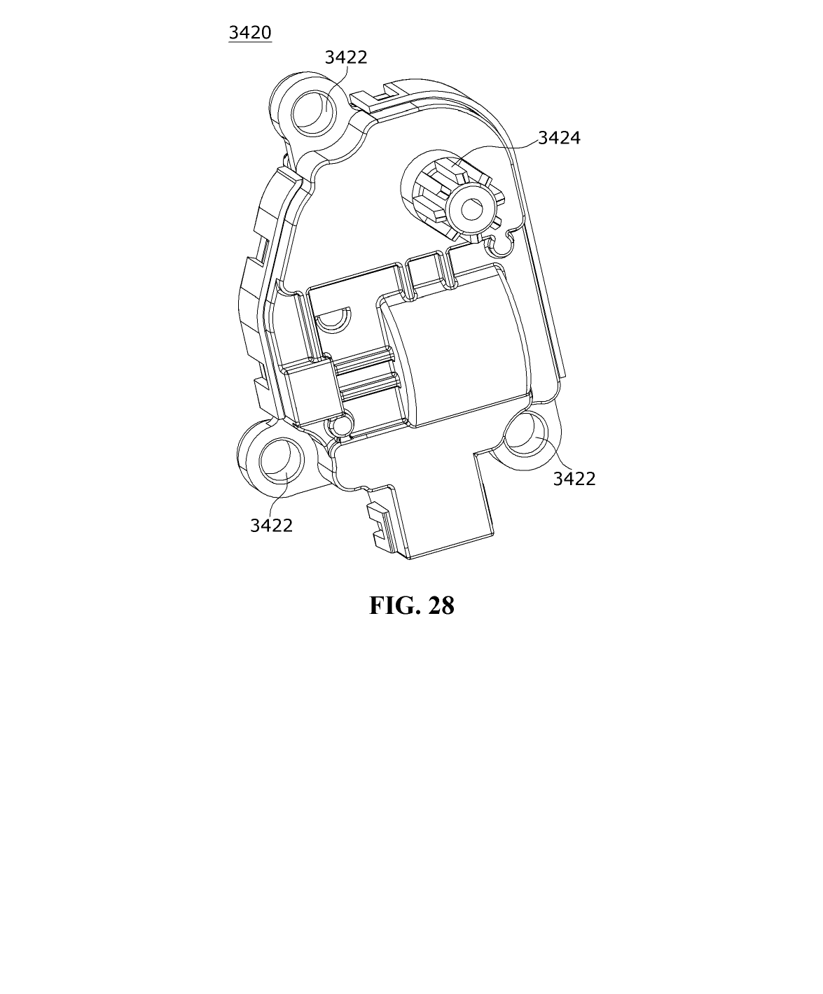

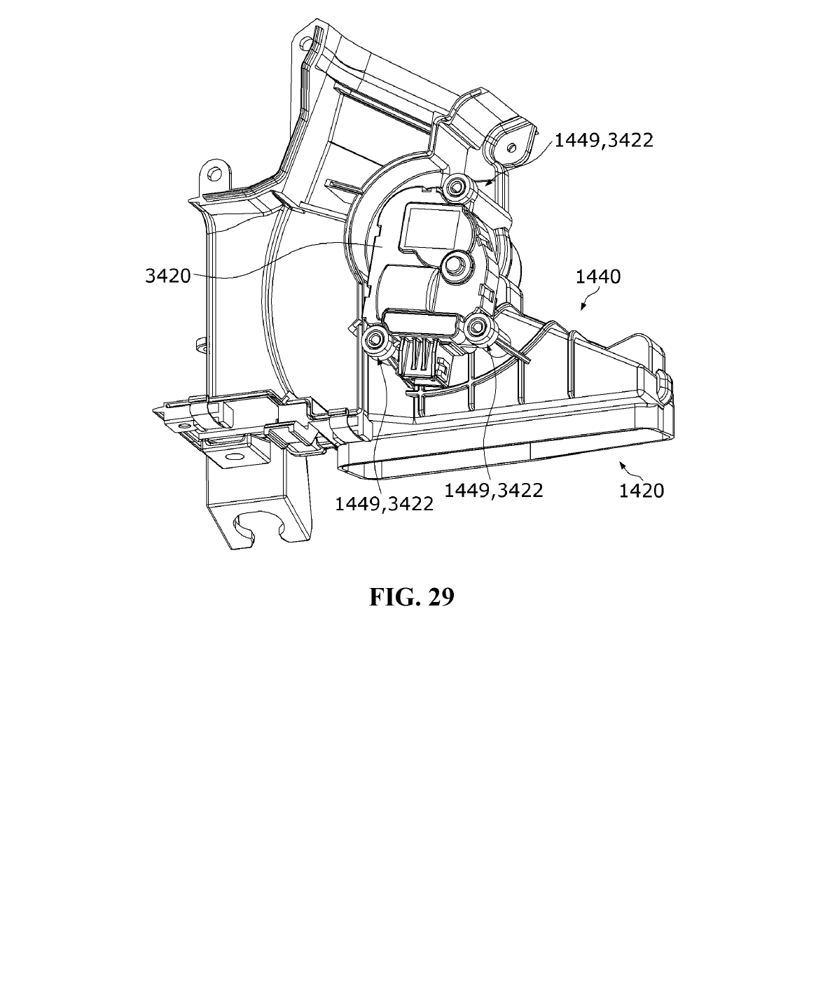

FIG. 28 is a view illustrating the second actuator, and FIG. 29 is a view illustrating the second actuator coupled to the second case unit.

Referring to FIGS. 28 and 29, the second actuator 3420 of the second door unit 3400 may include the 4-1 coupling parts 3422 and a 4-2 coupling part 3424.

The 4-1 coupling parts 3422 may be holes formed in the second actuator 3420. Each of the 4-1 coupling parts 3422 may have a size corresponding to an outer circumferential surface of the second coupling part 1449 of the fourth case frame 1440. The 4-1 coupling parts 3422 may be coupled to the second coupling parts 1449 of the fourth case frame 1440. The present embodiment in which three 4-1 coupling parts 3422 are provided is disclosed, but the present invention is not limited thereto. As the 4-1 coupling parts 3422 are coupled to the second coupling parts 1449 of the fourth case frame 1440, the second actuator 3420 may be fixed to the second case unit 1400.

The 4-2 coupling part 3424 may be a protrusion formed on the second actuator 3420. In this case, the second actuator 3420 may include a power generation part which receives power from the outside and generates power and a frame part which surrounds the power generation part to protect the power generation part. The 4-2 coupling part 3424 may be the protrusion which is connected to the power generation part of the second actuator 3420, passes through the frame part, and protrudes outward from the frame part, may be disposed on the frame part of the second actuator 3420, or may be a portion which is connected to the power generation part and rotated along the power generation part. The 4-2 coupling part 3424 may be coupled to a second shaft part 3444. When the 4-2 coupling part 3424 is rotated by the power generated by the power generation part, the second shaft part 3444 may be rotated. Accordingly, the second door 3440 may be rotated about a rotation center, that is, the second shaft part 3444.

The first door unit 3200 and the second door unit 3400 of the door unit 3000 of the vehicle air-conditioning apparatus 2 according to another embodiment of the present invention may include components of the vehicle air-conditioning apparatus 1 according to the embodiment of the present invention excluding the first lever and the second lever. Accordingly, as described above, the first door 3240 and the second door 3440 may be directly coupled to the first case unit 1200 and the second case unit 1400, respectively, to directly transmit the power, by which the first door 3240 and the second door 3440 are rotated, to the first actuator 3220 and the second actuator 3420 instead of indirect power transmission through the levers. Accordingly, the rotational stability of the doors can be secured.

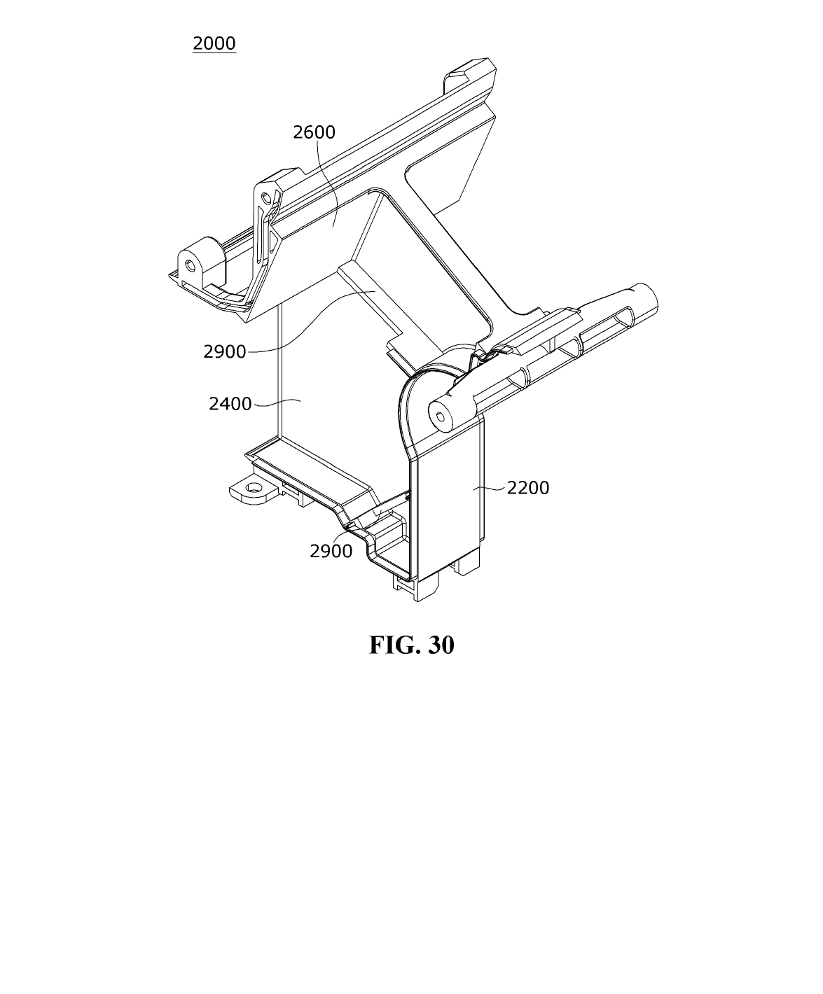

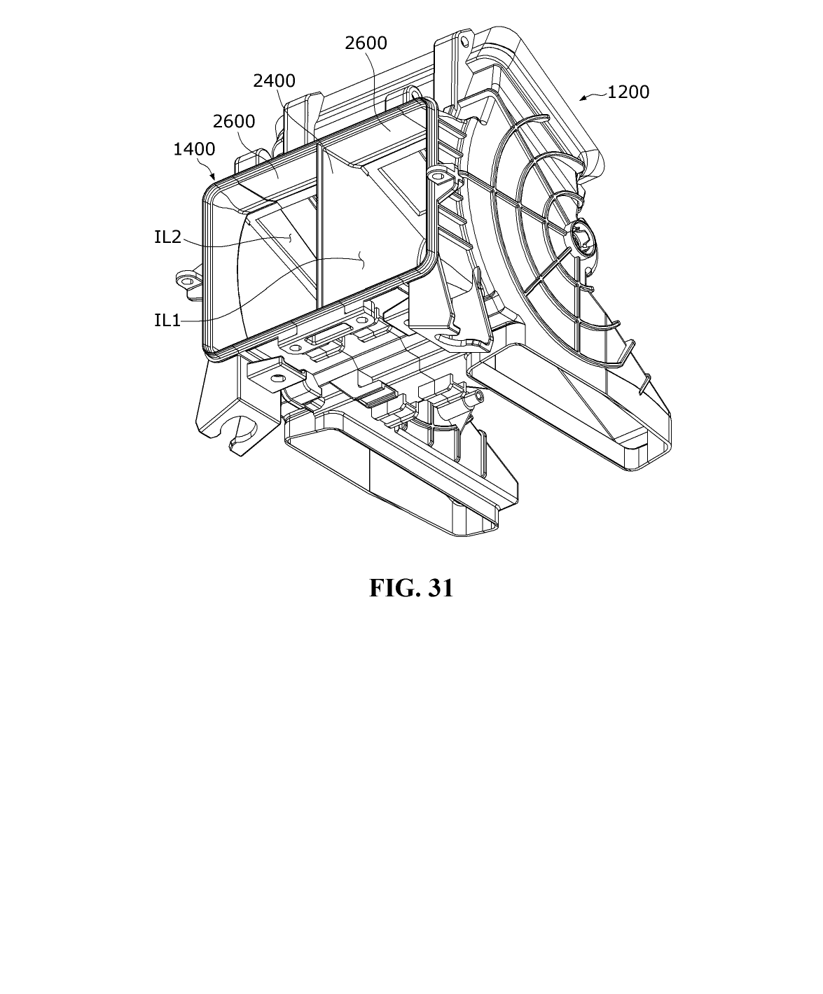

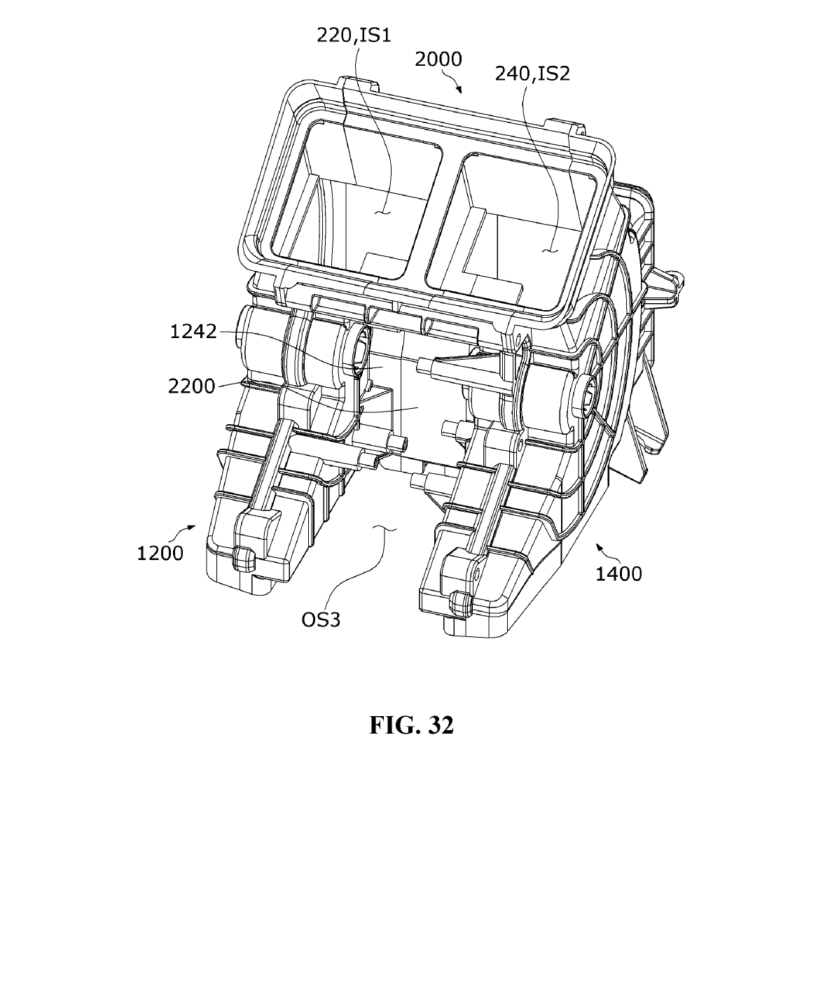

FIG. 30 is a view illustrating the separator, FIG. 31 is a view illustrating a first inlet part and a second inlet part formed by the first case unit, the second case unit, and the separator, and FIG. 32 is a view illustrating a third outer space formed by the first case unit, the second case unit, and the separator.

Referring to FIGS. 30 to 32, the separator 2000 of the vehicle air-conditioning apparatus 2 according to another embodiment of the present invention include a third partition plate 2200, a fourth partition plate 2400, a shielding plate 2600, and a third stopper part 2900.

The third partition plate 2200 may be disposed between the first case unit 1200 and the second case unit 1400 of the housing 1000. As illustrated in FIG. 32, with a first partition plate 1242 of the second case frame 1240 and a second partition plate 1442 of the fourth case frame 1440, the third partition plate 2200 may serve as a partition wall which divides a space through which air moves and the other space.

The fourth partition plate 2400 may be disposed to intersect the third partition plate 2200 and disposed between a first side plate 1244 of the first case unit 1200 and a second side plate 1444 of the second case unit 1400.

In addition, the fourth partition plate 2400 may support the third partition plate 2200 and separate a space formed between the first case unit 1200 and the second case unit 1400 of the housing 1000. In this case, as illustrated in FIG. 30, the fourth partition plate 2400 may be disposed between the third partition plate 2200 and the shielding plate 2600.

The shielding plate 2600 may be connected to the fourth partition plate 2400. The shielding plate 2600 may be disposed in a direction intersecting the fourth partition plate 2400. The shielding plate 2600 may be disposed to be spaced apart from the third partition plate 2200 with the fourth partition plate 2400 interposed therebetween. As illustrated in FIGS. 31 and 32, the shielding plate 2600 may be disposed between the first case unit 1200 and the second case unit 1400 of the housing 1000. Accordingly, the shielding plate 2600 may shield an open portion of the housing 1000.

The shielding plate 2600 may form an air flow path. In addition, as illustrated in FIG. 31, with the housing 1000 and the fourth partition plate 2400, the shielding plate 2600 may form a first inlet part and a second inlet part through which air is introduced into the housing 1000.

Since the third stopper part 2900 is the same as the third stopper part 2900 of the vehicle air-conditioning apparatus 1 according to the embodiment of the present invention, the description thereof will be omitted.

As described above, the vehicle air-conditioning apparatus 2 according to another embodiment of the present invention may have a third outer space unified by the separator 2000 as illustrated in FIG. 32. The unified third outer space may be disposed in front of the separator 2000. Accordingly, a difficulty in arranging the first actuator 3220 and the second actuator 3420 can be reduced, and a degree of arrangement freedom can be secured.

According to an embodiment of the present invention, since actuators for rotating doors disposed to open or close a plurality of air discharge regions formed by a housing and a separator are disposed in the housing, reduction of an air discharge area can be prevented while an entire size is not increased.

In addition, since an actuator is disposed inside a housing and disposed outside an air discharge region formed by the housing and a separator, the actuator does not overlap the air discharge region, and an increase in entire size of an air guide unit can be prevented. Accordingly, a difficulty in installing the actuator in an armrest can be reduced to reduce an installation time.

While the present invention has been described above with reference to exemplary embodiments, it may be understood by those skilled in the art that various modifications and changes of the present invention may be made within a range not departing from the spirit and scope of the present invention defined by the appended claims. In addition, it should be interpreted that differences related to modifications and changes fall within the scope of the present invention defined by the appended claims.

What is claimed is:

1. A vehicle air-conditioning apparatus which provides conditioned air to an interior of a vehicle equipped with the vehicle air-conditioning apparatus, the vehicle air-conditioning apparatus comprising:
a housing which includes an inlet part through which air is introduced and a discharge unit part which discharges air and is divided into a first inner space and a second inner space;
a door which is disposed in each of the first inner space and the second inner space and determines a moving direction of air; and
an actuator which rotates the door,
wherein the actuator is disposed between the first inner space and the second inner space.

2. The vehicle air-conditioning apparatus of claim 1, wherein the discharge unit part includes:
a first discharge part which discharges air toward an upper side; and
a second discharge part which discharges air toward a lower side,
wherein the actuator is disposed between the plurality of second discharge part.

3. The vehicle air-conditioning apparatus of claim 2, wherein the second discharge part and the actuator are disposed within a left-right width of the first discharge part.

4. The vehicle air-conditioning apparatus of claim 1, comprising:
a first duct which allows air to flow to the first inner space;
a second duct which allows air to flow to the second inner space; and
a blower unit which is disposed between the first duct and the second duct and discharges air toward the housing.

5. The vehicle air-conditioning apparatus of claim 2, comprising a separator which separates the first inner space and the second inner space,
wherein the housing includes a first case unit in which the first inner space and a first outer space are formed and a second case unit in which the second inner space and a second outer space are formed, and
the actuator is disposed in each of the first outer space and the second outer space which are formed between the first inner space and the second inner space.

6. The vehicle air-conditioning apparatus of claim 5, wherein the actuator is disposed close to the separator and spaced apart from the first case unit and the second case unit.

7. The vehicle air-conditioning apparatus of claim 5, wherein the actuator is disposed in each of a right outer portion of the first case unit and a left outer portion of the second case unit.

8. The vehicle air-conditioning apparatus of claim 5, wherein:
the actuator includes a first actuator disposed in the first outer space and a second actuator disposed in the second outer space; and
the door includes a first door disposed in the first inner space and a second door disposed in the second inner space.

9. The vehicle air-conditioning apparatus of claim 8, comprising:
a first lever which is disposed in the first outer space and connects the first actuator and the first door; and
a second lever which is disposed in the second outer space and connects the second actuator and the second door.

10. The vehicle air-conditioning apparatus of claim 9, wherein:
the first lever includes a 1-1 lever plate rotatably connected to the first actuator and a 1-2 lever plate which connects the first door and the 1-1 lever plate; and
the second lever includes a 2-1 lever plate rotatably connected to the second actuator and a 2-2 lever plate which connects the second door and the 2-1 lever plate.

11. The vehicle air-conditioning apparatus of claim 5, wherein:
the first case unit of the housing includes a first case frame disposed to be spaced apart from the separator and a second case frame which is disposed between the first case frame and the separator and connects the first case frame and the separator; and
the second case unit of the housing includes a third case frame disposed to be spaced apart from the separator and a fourth case frame which is disposed between the third case frame and the separator and connects the third case frame and the separator.

12. The vehicle air-conditioning apparatus of claim 5, wherein the first discharge part includes:
1-1 discharge part which is formed by the first case unit and discharges air to the lower side; and
1-2 discharge part which is formed by the second case unit and discharges air to the lower side.

13. The vehicle air-conditioning apparatus of claim 12, wherein the second discharge part includes:
a 2-1 discharge part formed by the first case unit and the separator; and
a 2-2 discharge part formed by the second case unit and the separator.

14. The vehicle air-conditioning apparatus of claim 8, wherein:
the first door is rotatably coupled to the first case unit;
the second door is rotatably coupled to the second case unit; and
a rotation center of the first door and a rotation center of the second door are disposed to be colinear with each other.

15. The vehicle air-conditioning apparatus of claim 5, wherein the separator includes a partition plate which separates the first inner space and the second inner space and divides the inlet part,
wherein the partition plate is coupled to the actuator to support the actuator.

16. The vehicle air-conditioning apparatus of claim 15, wherein the actuator is disposed between the first case unit and the second case unit of the housing and disposed at each of one side and the other side of the partition plate of the separator.

17. The vehicle air-conditioning apparatus of claim 16, wherein the actuator is disposed between the first case unit and the second case unit of the housing and disposed to be closer to the separator than the first case unit and the second case unit.

18. The vehicle air-conditioning apparatus of claim 15, wherein the separator includes a shielding plate which is coupled to the partition plate and forms the inlet part with the first case unit and the second case unit of the housing.

19. The vehicle air-conditioning apparatus of claim 15, wherein the separator includes a fixing protrusion which is disposed on an end portion of the partition plate and of which both end portions are fixed to the first case unit and the second case unit of the housing.
